(19) United States
(12) Patent Application Publication
(10) Pub. No.: US 2026/0058937 A1
(43) Pub. Date: Feb. 26, 2026

(54) DATA PROCESSING

(71) Applicant: Tencent Technology (Shenzhen) Company Limited, Shenzhen (CN)

(72) Inventors: Haotian LONG, Shenzhen (CN); Rongbin ZHOU, Shenzhen (CN); Canhui HUANG, Shenzhen (CN)

(73) Assignee: Tencent Technology (Shenzhen) Company Limited, Shenzhen (CN)

(21) Appl. No.: 19/308,087

(22) Filed: Aug. 22, 2025

Related U.S. Application Data
(63) Continuation of application No. PCT/CN2024/102339, filed on Jun. 28, 2024.

(30) Foreign Application Priority Data
Jul. 14, 2023 (CN) 202310864633.6

(51) Int. Cl. H04L 9/40; H04L 9/08

(52) U.S. Cl. CPC H04L 63/0428; H04L 9/0825

(57) ABSTRACT

In a method of data processing, when a service request is initiated by an application running on a terminal device, a temporary key is allocated to the service request. The temporary key is encrypted by using a certificate public key, to obtain an encrypted temporary key, the certificate public key is preset in a source code of the application, and a certificate private key associated with the certificate public key is stored in a server for the application. Request data of the service request is encrypted by using the temporary key, to obtain at least a ciphertext. A network response request packet is generated based on the encrypted temporary key and the ciphertext. The network response request packet is transmitted to the server, the network response request packet requests the server to respond to the service request. Apparatus and non-transitory computer-readable storage medium counterpart embodiments are also contemplated.

### RELATED APPLICATIONS

The present application is a continuation of International Application No. PCT/CN2024/102339, filed on Jun. 28, 2024, which claims priority to Chinese Patent Application No. 202310864633.6, filed on Jul. 14, 2023. The entire disclosures of the prior applications are hereby incorporated by reference.

### FIELD OF THE TECHNOLOGY

This application relates to the field of Internet technologies, including a data processing method, a data processing apparatus, a computer device, a computer-readable storage medium, and a computer program product.

### BACKGROUND OF THE DISCLOSURE

Currently, to ensure that data is not stolen in a transmission process, during data transmission, data to be transmitted may be encrypted, and then encrypted data is transmitted. An existing data encryption mode is mainly as follows: Two communication parties (for example, an application (APP) running on a terminal device and a server) first establish an encrypted channel, and then exchange keys through the encrypted channel. After obtaining a same key as the server, the application encrypts data by using the key, and transmits encrypted data to the server. However, in this process, the server needs to maintain a correspondence between a negotiated key and an application, causing high resource overheads of the server. Therefore, how to reduce resource overheads of the server while ensuring data security in a data transmission process has become a hot research topic.

### SUMMARY

Embodiments of this disclosure provide a data processing method and a related device, to ensure data security in a data transmission process and reduce resource overheads of a server.

Some aspects of the disclosure provide a method of data processing. In some examples, when a service request is initiated by an application running on a terminal device, a temporary key is allocated to the service request. The temporary key is encrypted by using a certificate public key, to obtain an encrypted temporary key, the certificate public key is preset in a source code of the application, and a certificate private key associated with the certificate public key is stored in a server for the application. Request data of the service request is encrypted by using the temporary key, to obtain at least a ciphertext. A network response request packet is generated based on the encrypted temporary key and the ciphertext. The network response request packet is transmitted to the server, the network response request packet requests the server to respond to the service request.

Some aspects of the disclosure provide an apparatus that includes processing circuitry configured to perform the method of data processing.

Some aspects of the disclosure also provide a non-transitory computer-readable storage medium storing instructions which when executed by at least one processor cause the at least one processor to perform the method of data processing.

Some aspects of the disclosure provide another method of data processing. In some examples, a network response request packet that is transmitted based on an application running on a terminal device is received by a server for the application. The network response request packet includes an encrypted temporary key and a ciphertext of a service request from the terminal device. The encrypted temporary key is decrypted by using a certificate private key to recover a temporary key, the temporary key is allocated to the service request and is encrypted into the encrypted temporary key based on a certificate public key, the certificate public key is associated with the certificate private key and is preset in a source code of the application. The ciphertext is decrypted by using the temporary key, to obtain request data of the service request. A response to the service request is generated based on the request data.

Some aspects of the disclosure provide an apparatus that includes processing circuitry configured to perform the other method of data processing.

Some aspects of the disclosure also provide a non-transitory computer-readable storage medium storing instructions which when executed by at least one processor cause the at least one processor to perform the other method of data processing.

According to an aspect, an embodiment of this disclosure provides a data processing method. The method includes: obtaining, when detecting a service request initiated by an application, a temporary key (e.g., randomly) allocated to the service request; encrypting the temporary key by using a certificate public key, to obtain an encrypted temporary key, the certificate public key being preset in a source code of the application, and a certificate private key corresponding to the certificate public key being stored in a server; encrypting request data of the service request by using the temporary key, to obtain a ciphertext; and generating a network response request packet based on the encrypted temporary key and the ciphertext, and transmitting the network response request packet to the server, the network response request packet being configured for requesting the server to respond to the service request.

According to an aspect, an embodiment of this disclosure provides a data processing method. The method includes: receiving a network response request packet transmitted by an application, the network response request packet including an encrypted temporary key and a ciphertext; decrypting the encrypted temporary key by using a certificate private key, a temporary key (e.g., randomly) allocated to a service request of the application being obtained through decryption if the encrypted temporary key is obtained through encryption with a certificate public key that is preset in a source code of the application; decrypting the ciphertext by using the temporary key, to obtain request data of the service request; and making a response to the service request based on the request data.

According to an aspect, an embodiment of this disclosure provides a data processing apparatus. The apparatus includes: a processing unit, configured to obtain, when detecting a service request initiated by an application, a temporary key (e.g., randomly) allocated to the service request; the processing unit being further configured to encrypt the temporary key by using a certificate public key, to obtain an encrypted temporary key, the certificate public key being preset in a source code of the application, and a certificate private key corresponding to the certificate public key being stored in a server; the processing unit being further configured to encrypt request data of the service request by using the temporary key, to obtain a ciphertext; the processing unit being further configured to generate a network response request packet based on the encrypted temporary key and the ciphertext; and a transmission unit, configured to transmit the network response request packet to the server, the network response request packet being configured for requesting the server to respond to the service request.

The processing unit is configured to encrypt the temporary key by using the certificate public key based on a first encryption algorithm, to obtain the encrypted temporary key.

The processing unit is configured to encrypt the request data of the service request by using the temporary key based on a second encryption algorithm, to obtain the ciphertext, the first encryption algorithm being different from the second encryption algorithm.

The temporary key includes a first subkey. The processing unit is configured to: obtain the first subkey from the temporary key; and encrypt the request data of the service request by using the first subkey based on the second encryption algorithm, to obtain the ciphertext.

The temporary key further includes a second subkey. The processing unit is configured to: perform a digest operation on the encrypted temporary key and the ciphertext by using the second subkey, to obtain a message authentication code; and encapsulate the encrypted temporary key, the ciphertext, and the message authentication code to form the network response request packet.

The processing unit is configured to: determine the encrypted temporary key as a packet header, determine the ciphertext as a packet body, and determine the message authentication code as a packet trailer; and concatenate the packet header, the packet body, and the packet trailer to form the network response request packet.

The processing unit is further configured to: obtain a priority of the request data; obtain a key length matching the priority of the request data; and allocate the temporary key (e.g., randomly) to the service request based on the matching key length.

A higher priority of the request data indicates a higher importance level of the request data and a larger matching key length.

The processing unit is further configured to: obtain the priority of the request data and a key length of the temporary key; and determine the second encryption algorithm based on one or two of the priority of the request data or the key length of the temporary key.

A higher priority of the request data indicates higher complexity of the second encryption algorithm. A larger key length of the temporary key indicates higher complexity of the second encryption algorithm.

The application is an installation-free application. The application is run in a security sandbox. A method is run in the security sandbox. The processing unit is further configured to: verify the network response request packet in the security sandbox; and perform, if the network response request packet is successfully verified, the operation of transmitting the network response request packet to the server.

The verification includes any one of the following: verifying validity of the certificate public key; and verifying normativity of the network response request packet.

The verifying normativity of the network response request packet includes at least one of the following: verifying whether data in the network response request packet is encrypted, and determining, if it is determined that the data in the network response request packet is not encrypted, that the normativity of the network response request packet fails to be verified, or determining, if it is determined that the data in the network response request packet is encrypted, that the normativity of the network response request packet is successfully verified; verifying whether the encrypted temporary key is obtained through encryption with a certificate public key that is successfully verified, and determining, if the encrypted temporary key is obtained through encryption with the certificate public key that is successfully verified, that the normativity of the network response request packet is successfully verified, or determining, if the encrypted temporary key is not obtained through encryption with the certificate public key that is successfully verified, that the normativity of the network response request packet fails to be verified; and verifying whether a format of the network response request packet is a preset format, and determining, if the format of the network response request packet is the preset format, that the normativity of the network response request packet is successfully verified, or determining, if the format of the network response request packet is not the preset format, that the normativity of the network response request packet fails to be verified, the preset format being that the packet header of the network response request packet is the encrypted temporary key, the packet body is the ciphertext, and the packet trailer is the message authentication code.

In some examples, random allocation means allocating one temporary key to one service request, temporary keys allocated to different service requests being different.

The first encryption algorithm includes an asymmetric encryption algorithm. The asymmetric encryption algorithm includes at least one of the following: an elliptic curve public key cryptography algorithm, an asymmetric encryption algorithm based on a large integer factorization problem, or a digital signature algorithm.

The second encryption algorithm includes a symmetric encryption algorithm. The symmetric encryption algorithm includes at least one of the following: a key-based block cipher algorithm, a block cipher algorithm, a triple data encryption algorithm, or an advanced encryption standard algorithm.

According to an aspect, an embodiment of this disclosure provides a data processing apparatus. The apparatus includes: a receiving unit, configured to receive a network response request packet transmitted by an application, the network response request packet including an encrypted temporary key and a ciphertext; and a processing unit, configured to decrypt the encrypted temporary key by using a certificate private key, a temporary key (e.g., randomly) allocated to a service request of the application being obtained through decryption if the encrypted temporary key is obtained through encryption with a certificate public key that is preset in a source code of the application.

The processing unit is further configured to decrypt the ciphertext by using the temporary key, to obtain request data of the service request.

The processing unit is further configured to make a response to the service request based on the request data.

The temporary key includes a first subkey and a second subkey, the first subkey being configured for decrypting the ciphertext. The network response request packet further includes a message authentication code. The processing unit is further configured to: perform a digest operation on the encrypted temporary key and the ciphertext by using the second subkey, to obtain an operated message authentication code; perform consistency comparison between the operated message authentication code and the message authentication code in the network response request packet; and perform, if consistency comparison succeeds, an operation of decrypting the ciphertext by using the temporary key based on a second encryption algorithm, to obtain the request data of the service request.

The processing unit is configured to: determine, based on the request data, a service processing device corresponding to the service request; and forward the service request to the service processing device for service processing.

According to an aspect, an embodiment of this disclosure provides a computer device. The computer device includes: a processor, adapted to running a computer program; and a computer-readable storage medium (e.g., non-transitory computer-readable storage medium), the computer-readable storage medium having the computer program stored therein, and the computer program, when executed by the processor, causing the foregoing data processing method to be implemented.

According to an aspect, an embodiment of this disclosure provides a computer-readable storage medium. The computer-readable storage medium has a computer program stored therein. The computer program, when loaded and executed by a processor (an example of processing circuitry), causes the foregoing data processing method to be implemented.

According to an aspect, an embodiment of this disclosure provides a computer program product. The computer program product includes a computer program or computer instructions. The computer program or the computer instructions, when executed by a processor, cause the foregoing data processing method to be implemented.

In the embodiments of this disclosure, the temporary key (e.g., randomly) allocated to the service request is obtained when detecting the service request initiated by the application. Then, the temporary key is encrypted by using the certificate public key, to obtain the encrypted temporary key, and the request data of the service request is encrypted by using the temporary key, to obtain the ciphertext. The network response request packet is generated based on the encrypted temporary key and the ciphertext, and the network response request packet is transmitted to the server, the network response request packet being configured for requesting the server to respond to the service request. According to the foregoing solution, it can be learned that the server does not need to generate the temporary key and maintain a status of the temporary key. The server only needs to passively receive the encrypted temporary key transmitted by the application, and then decrypt, by using the certificate private key in the server, the temporary key for decrypting the ciphertext. It can be learned that the server can securely obtain the temporary key only by generating the certificate public key and the corresponding certificate private key, and does not need to generate and maintain a temporary key for each service request. This can reduce data processing of the server to some extent and reduce resource overheads of the server. In addition, because the certificate private key is stored only in the server, the encrypted temporary key obtained through encryption with the certificate public key can only be decrypted by the server, which can well ensure security of the temporary key. Because the temporary key is adequately secure, the ciphertext obtained through encryption with the temporary key is also adequately secure. Therefore, data security in a data transmission process can be well ensured by separately encrypting the temporary key and the request data of the service request.

### BRIEF DESCRIPTION OF THE DRAWINGS

FIG. 1a is a diagram of an architecture of a data processing system according to an exemplary embodiment of this disclosure.

FIG. 1b is a schematic diagram of an encryption procedure according to an exemplary embodiment of this disclosure.

FIG. 1c is a schematic diagram of a decryption procedure according to an exemplary embodiment of this disclosure.

FIG. 2 is a schematic flowchart of a data processing method according to an exemplary embodiment of this disclosure.

FIG. 3 is a schematic flowchart of a data processing method according to another exemplary embodiment of this disclosure.

FIG. 4 is a schematic flowchart of a data processing method according to still another exemplary embodiment of this disclosure.

FIG. 5 is a schematic flowchart of a data processing method according to yet another exemplary embodiment of this disclosure.

FIG. 6 is a schematic diagram of a structure of a data processing apparatus according to an exemplary embodiment of this disclosure.

FIG. 7 is a schematic diagram of a structure of a data processing apparatus according to another exemplary embodiment of this disclosure.

FIG. 8 is a schematic diagram of a structure of a computer device according to an exemplary embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Related technical terms in the embodiments of this disclosure are first described.

### 1: Application

The application may be an application (APP) that corresponds to a server and that provides a local service for an object. In an implementation, the application may be an APP installed and run on a terminal device, and the application may include but is not limited to a social application, a game application, a payment application, and the like. In another implementation, the application may be an installation-free application (for example, an applet). In yet another implementation, the application may be a website providing the local service for the object, for example, a social website providing a social conversation function for the object or a game website providing a game service for a customer.

### 2: Asymmetric Encryption Algorithm

The asymmetric encryption algorithm is an algorithm in which different keys are used in an encryption process and a decryption process. For example, it is assumed that when two communication parties (for example, a terminal device and a server) exchange data, the terminal device and the server first exchange their respective public keys. Then, when exchanging data, the terminal device may encrypt the to-be-exchanged data by using the public key (that is, a certificate public key) of the server. After receiving encrypted data, the server may decrypt the encrypted data by using a private key (that is, a certificate private key) of the server. Therefore, the asymmetric encryption algorithm is also referred to as a public key encryption algorithm.

The asymmetric encryption algorithm may include but is not limited to an elliptic curve public key cryptography algorithm (SM2, a Chinese national cryptographic algorithm), an asymmetric encryption algorithm based on a large integer factorization problem (RSA, initial letters of surnames of Ron Rivest, Adi Shamir, and Leonard Adleman), and a digital signature algorithm (DSA).

All the asymmetric encryption algorithms can encrypt data, thereby ensuring data security. However, different asymmetric encryption algorithms have different characteristics, for example, RSA has weak encryption strength and a high encryption and decryption speed, and SM2 has strong encryption strength (that is, encryption complexity) and a low encryption and decryption speed.

### 3: Symmetric Encryption Algorithm

The symmetric encryption algorithm is an algorithm in which a same key is used for encryption and decryption. For example, it is assumed that two communication parties exchange (transmit) data, one of the two communication parties may encrypt data by using a key A, and the other party decrypts encrypted data by using the key A.

The symmetric encryption algorithm may include but is not limited to a key-based block cipher algorithm (data encryption standard, DES), a block cipher algorithm (SM4, a Chinese national cryptographic algorithm), a triple data encryption algorithm (DES3), or an advanced encryption standard (AES) algorithm.

All the symmetric encryption algorithms can encrypt data, thereby ensuring data security. However, different symmetric encryption algorithms have different characteristics, for example, the DES has a small key length, a high encryption speed, and weak encryption strength, DES3 has a large key length, low encryption speed, and strong encryption strength, and AES has a large key length, high encryption speed, and strong encryption strength.

### 4: Message Authentication Code

The message authentication code is configured for verifying integrity of data. The message authentication code is obtained by performing a digest operation on the data by using a key. Whether an operated message authentication code obtained through the operation is consistent with a message authentication code in the data may be determined through comparison, to determine whether the data is complete. When the operated message authentication code obtained through the operation is inconsistent with the message authentication code in the data, it is determined that the data has a risk of being tampered with; or when the operated message authentication code obtained through the operation is consistent with the message authentication code in the data, it may be determined that the data is complete and is not tampered with.

### 5: Security Sandbox

The security sandbox is a mechanism for protecting privacy of an object and system security. The security sandbox may limit an application in a closed running environment, preventing a potential threat caused by the application to a system and another application. In addition, the security sandbox may provide some virtual hardware and software resources, such as a file system, a network, and an operating system, so that the application can run in a virtual environment without causing any bad impact to a computer system. If the application attempts to access a resource outside the sandbox or performs a dangerous operation, the sandbox intercepts these requests and takes corresponding security measures.

In the embodiments of this disclosure, data may be encrypted in the security sandbox, to ensure security during data encryption. In addition, a to-be-transmitted network response request packet may be further verified in the security sandbox, to ensure that data in the transmitted network response request packet is encrypted data.

### 6: Temporary Key

The temporary key is a key that is valid in one service request. In some examples, the temporary key has a valid time, and the valid time may be time corresponding to the one service request. After a response is made to the service request, the temporary key becomes invalid. A new temporary key is allocated for a next service request.

In the embodiments of this disclosure, the temporary key may include a first subkey and a second subkey. The first subkey may be configured for encrypting request data of the service request. The first subkey may also be referred to as a symmetric key. The second subkey may be configured for generating a message authentication code for verifying data integrity. The second subkey may also be referred to as a message authentication key.

The following briefly describes a common data encryption algorithm.

During data transmission, a common data encryption algorithm includes but is not limited to an asymmetric encryption algorithm, a hybrid encryption scheme based on an integrated key encryption scheme, an encryption scheme based on a key exchange protocol, and the like. Next, related descriptions of a process of performing data encryption by using the foregoing data encryption algorithm are provided.

(1) The asymmetric encryption algorithm: During data transmission, data may be encrypted directly by using the asymmetric encryption algorithm. In some aspects, an example in which the asymmetric encryption algorithm is an SM2 algorithm defined by a Chinese national cryptographic algorithm is used. Encrypting the data by using the asymmetric encryption algorithm may include: first generating a temporary elliptic curve point by using an elliptic curve and a public key, then generating a derived key by using a key derivation function, the elliptic curve point, and a length of data, and directly performing exclusive OR processing on the derived key and the data to obtain a ciphertext.

(2) The hybrid encryption scheme includes an integrated encryption scheme (IES) and an elliptic curve variant scheme thereof (elliptic curve integrate encrypt scheme, ECIES). During data transmission, a temporary asymmetric public key and key are first generated, and then the temporary asymmetric public key and key are processed by using a key agreement (KA) function, to generate a master key. Then, derivation processing is performed on the master key by using a key derivation function, to generate a symmetric key and a message authentication key. Finally, data is encrypted by using the symmetric key, to obtain a ciphertext, and a digest operation is performed on the ciphertext by using the message authentication key, to obtain a message authentication code.

(3) The encryption scheme based on the key exchange protocol: The key exchange protocol (authenticated key exchange, AKE) is used to negotiate a temporary key through a series of key exchange processes, and in a process of negotiating the temporary key, a symmetric key is generated by combining a message digest algorithm and a key agreement algorithm. Then, after the symmetric key is generated, when two communication parties (for example, an application and a server) establish an encrypted channel, the application and the server first complete symmetric key exchange. In some examples, the application may transmit the symmetric key to the server, and the server may receive the symmetric key transmitted by the application. Finally, the application and the server obtain the same symmetric key. Then, the application may encrypt data by using the symmetric key, to obtain a ciphertext, and transmit the ciphertext to the server.

The foregoing data encryption algorithm can improve data security during data transmission, but still has the following problems.

1: For the asymmetric encryption algorithm, an elliptic curve point needs to be calculated by using the asymmetric encryption algorithm each time data is encrypted, and performance of the asymmetric encryption algorithm has a large difference from performance of the symmetric encryption algorithm. The performance herein may include a data encryption speed and the like. For example, an encryption speed of the symmetric encryption algorithm is higher than the performance of the asymmetric encryption algorithm. In addition, when the key derivation function (such as the KDF) expands an original key, only security of a length of the original key can be ensured. The key length is limited by a key length for asymmetric encryption, and the security is not as good as that of the symmetric encryption algorithm.

2: The key agreement function usually generates a key by performing a multiplication operation on scalar points on an elliptic curve. For example, in the integrated encryption scheme (IES) and the elliptic curve variant scheme thereof (ECIES), a scalar point multiplication operation is usually performed by using a scalar point multiplication operation interface of an elliptic curve secp256k1 (an elliptic curve based on Fp (finite field)), to obtain the master key. However, in the Chinese national cryptographic algorithm, an underlying interface related to elliptic curves is usually encapsulated without exposure to the outside, so that during actual development, the key agreement function cannot be implemented by using the elliptic curve allowed in the Chinese national cryptographic algorithm.

3: The key derivation function is usually a key derivation algorithm that can resist a brute force attack, such as BLAKE3 (a cryptographic hash algorithm). The key derivation function in the integrated encryption scheme is a hash-based message authentication code (HMAC)-based key derivation function (HKDF) algorithm based on HMAC-SHA1. Currently, the HKDF has a limited effect of resisting a graphics processing unit (GPU) accelerated brute force attack on the algorithm, and a symmetric key is easily obtained through a brute force attack, causing data leakage. In addition, the Chinese national cryptographic algorithm does not directly provide specification of the key derivation function. During actual development, an encapsulated key derivation function cannot be directly used, and secondary development needs to be performed based on an SM3 digest algorithm (a Chinese national cryptographic algorithm), requiring an additional workload and security proof.

4: When the key exchange protocol is used, a protocol handshake needs to be performed. In a handshake process, symmetric key exchange can usually be completed through one or more round-trip requests, increasing a data volume that needs to be processed on a server side and a request delay. For example, in a scenario of an application (for example, an applet), a network request delay is usually large and uncontrollable, and if the key exchange protocol is used, a delay of a first request is increased. In addition, the server needs to maintain a correspondence between a negotiated key and an application, increasing the data volume that needs to be processed on the server side and the request delay.

Based on this, an embodiment of this disclosure provides an end-to-end data processing solution. A general principle of the data processing solution is as follows: obtaining, when detecting a service request initiated by an application, a temporary key (e.g., randomly) allocated to the service request; encrypting the temporary key by using a certificate public key, to obtain an encrypted temporary key, the certificate public key being preset in a source code of the application, and a certificate private key corresponding to the certificate public key being stored in a server; encrypting request data of the service request by using the temporary key, to obtain a ciphertext; and generating a network response request packet (also referred to as network request packet in some examples) based on the encrypted temporary key and the ciphertext, and transmitting the network response request packet to the server, the network response request packet being configured for requesting the server to respond to the service request.

According to the foregoing solution, it can be learned that the server does not need to generate the temporary key and maintain a status of the temporary key. The server only needs to passively receive the encrypted temporary key transmitted by the application, and then decrypt, by using the certificate private key in the server, the temporary key for decrypting the ciphertext. It can be learned that the server can securely obtain the temporary key only by generating the certificate public key and the corresponding certificate private key, and does not need to generate and maintain a temporary key for each service request. This can reduce data processing of the server to some extent and reduce resource overheads of the server. In addition, because the certificate private key is stored only in the server, the encrypted temporary key obtained through encryption with the certificate public key can only be decrypted by the server, which can well ensure security of the temporary key. Because the temporary key is adequately secure, the ciphertext obtained through encryption with the temporary key is also adequately secure. Therefore, data security in a data transmission process can be well ensured by separately encrypting the temporary key and the request data of the service request.

Next, related descriptions of a data processing system provided in the embodiments of this application are provided.

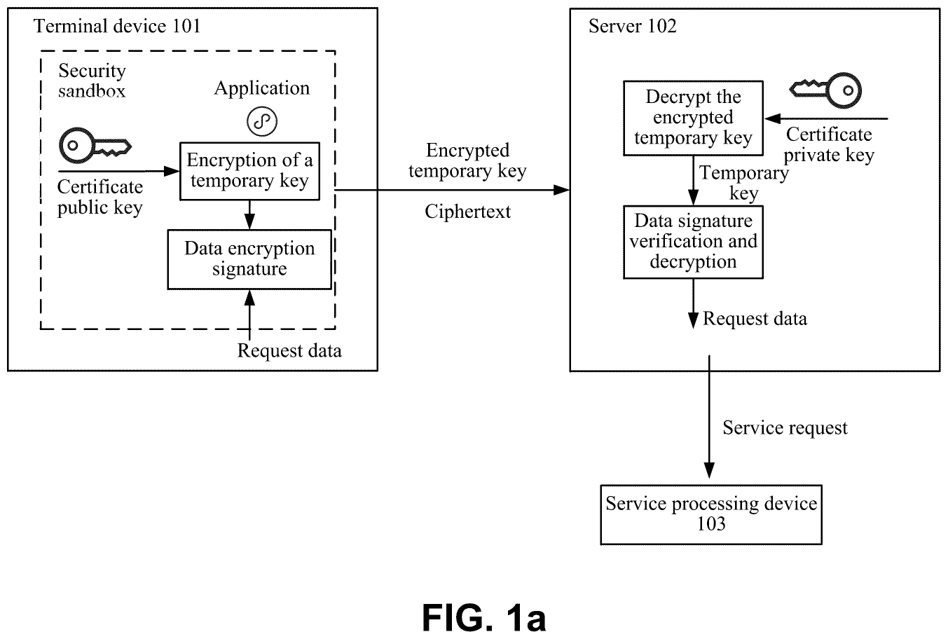

FIG. 1a is a diagram of an architecture of a data processing system according to an embodiment of this disclosure. As shown in FIG. 1a, the data processing system may include a terminal device 101, a server 102, and a service processing device 103. A quantity of terminal devices is not limited in this disclosure. Certainly, there may be a plurality of servers and a plurality of service processing devices, and a quantity of servers and a quantity of service processing devices are also not limited in this disclosure. The terminal device 101 in the data processing system may be directly or indirectly connected to the server 102 and the service processing device 103 in a wired or wireless communication manner. The server 102 and the service processing device 103 may exchange information.

An application is run on the terminal device 101. The application may be a social application, a game application, an installation-free application, or the like. The terminal device 101 may include, but not limited to, the following functions: 1: a temporary key encryption function: encrypting, by using a certificate public key, a temporary key allocated to a service request, to obtain an encrypted temporary key; and 2: a data encryption signature function: encrypting request data (that is, plaintext data) of the service request to obtain ciphertext, and performing signature processing on the to-be-transmitted encrypted temporary key and the ciphertext, to ensure integrity of the data. Signature herein is a process of generating a message authentication code.

In addition, if the application is the installation-free application, the installation-free application is also referred to as an applet or a subprogram. As shown in FIG. 1a, the terminal device 101 provides a security sandbox for the application, to ensure security of the application or a system. The terminal device may include but is not limited to a smartphone, a tablet computer, a notebook computer, a desktop computer, a smart speaker, a smartwatch, an in-vehicle terminal, a smart wearable device, and the like.

The server 102 may be a server that corresponds to the application and that provides technical support for a service provided by the application. The server 102 includes, but is not limited to, the following functions: 1: an encrypted temporary key decryption function: decrypting the encrypted temporary key to obtain the temporary key; 2: a data signature verification and decryption function: performing signature verification processing on the received encrypted temporary key and ciphertext to which a signature is added, to determine whether the received data is tampered with, and decrypting the ciphertext based on the temporary key, to obtain the request data of the service request; and 3: a service forwarding function: The server 102 may forward the service request for the application to the service processing device 103. The server 102 may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform.

The service processing device 103 may be configured to provide a service processing service for the application. For example, the service processing device 103 may provide the service processing service for the application in response to the service request transmitted by the server 102 for the application. The service processing device 103 may be a terminal device or a server. The terminal device may include but is not limited to a smartphone, a tablet computer, a notebook computer, a desktop computer, a smart speaker, a smartwatch, an in-vehicle terminal, a smart wearable device, and the like. The server may be an independent physical server, a server cluster or distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), and a big data and artificial intelligence platform.

In an embodiment, interaction among the terminal device 101, the server 102, and the service processing device 103 is used as an example to describe a data processing procedure. The data processing procedure includes two parts: a phase of encryption by the application and a phase of decryption by the server.

### (1) The Phase of Encryption by the Application

FIG. 1b is a schematic diagram of an encryption procedure according to an exemplary embodiment of this disclosure. In FIG. 1b, the phase of encryption by the application mainly includes five operations: generation of the temporary key, encryption of the temporary key, encryption of the request data of the service request, generation of the message authentication code, and generation of the network response request packet.

1: Generation of the temporary key: When detecting the service request for the application, the application in the terminal device 101 may independently generate the temporary key OTP (one time password) for the service request. A temporary key is independently generated for each service request. The temporary key may include a first subkey K_{ENC} and a second subkey K_{MAC}.

2: Encryption of the temporary key: The application encrypts the OTP by using a certificate public key (Pk), to obtain an encrypted temporary key Ex. In an implementation, the temporary key is encrypted by using the certificate public key (Pk) based on a first encryption algorithm (for example, an asymmetric encryption algorithm), to obtain the encrypted temporary key. In another implementation, the application is the installation-free application, and the installation-free application may be run in the security sandbox. In this case, the OTP may be encrypted in the security sandbox by using the certificate public key based on a first encryption algorithm, to obtain the encrypted temporary key.

3: Encryption of the request data of the service request: The application encrypts request data m of the service request by using the first subkey K_{ENC} in the temporary key, to obtain a ciphertext c. In an implementation, the request data m is encrypted by using the first subkey K_{ENC} in the temporary key based on a second encryption algorithm (for example, a symmetric encryption algorithm), to obtain the ciphertext. In another implementation, the request data m may be encrypted in the security sandbox by using the first subkey in the temporary key based on a second encryption algorithm, to obtain the ciphertext c.

4: Generation of the message authentication code: The application in the terminal device 101 performs signature processing on the ciphertext and the encrypted temporary key by using the second subkey in the temporary key, to obtain the message authentication code (Tag). The message authentication code may include a hash value. The signature processing means performing digest operation processing on the ciphertext and the encrypted temporary key by using the second subkey in the temporary key based on a message digest algorithm (such as an SM3 algorithm). In an implementation, signature processing may be performed on the ciphertext and the encrypted temporary key in the security sandbox by using the second subkey in the temporary key, to obtain the message authentication code. A length of the message authentication code may be determined based on the message digest algorithm. For example, the message digest algorithm is the SM3 algorithm. The length of the message authentication code may be 64 bits.

5: Generation of the network response request packet: The application may generate the network response request packet based on the encrypted temporary key, the ciphertext, and the message authentication code, and transmit the network response request packet to the server 102.

From the encryption procedure, it can be learned that the application may encrypt the temporary key based on the first encryption algorithm, and encrypt the request data by using the first subkey in the temporary key based on the second encryption algorithm, so that it can be ensured that data in the network response request packet is not stolen by another device in a transmission process, and data security is effectively ensured. In addition, because the first encryption algorithm is different from the second encryption algorithm, difficulty in cracking both the encrypted temporary key and the ciphertext is further increased, and the data security is further ensured. In addition, the temporary key is generated, so that a problem that an additional workload and security proof are required for secondary development based on the SM3 algorithm can be resolved. Moreover, the network response request packet includes the encrypted temporary key, and an encrypted channel does not need to be pre-established with the server to negotiate the temporary key, so that a data volume that needs to be processed on a server side and a request delay can be reduced to some extent. In addition, the message authentication code may be used to verify the integrity of the data in the network response request packet, so that the integrity of the transmitted data and integrity of the key can be ensured.

### (2) The Phase of Decryption by the Server

FIG. 1c is a schematic diagram of a decryption procedure according to an exemplary embodiment of this disclosure. In FIG. 1c, the phase of decryption by the server includes four operations: decryption with a private key, verification of the message authentication code, decryption of the ciphertext, and service processing.

1: Decryption with the private key: After receiving the network response request packet transmitted by the application, the server 102 may decrypt the encrypted temporary key Ek in the network response request packet by using a certificate private key Sk, to obtain the temporary key. The certificate private key may be stored in a storage space of the server. The server 102 may obtain the certificate private key from the storage space, and decrypt the encrypted temporary key in the network response request packet by using the certificate private key based on the first encryption algorithm, to obtain the temporary key.

2: Verification of the message authentication code: The server 102 may perform integrity verification on the network response request packet. If integrity verification of the network response request packet succeeds, operation 3 is performed; or if integrity verification of the network response request packet fails, prompt information is outputted, the prompt information being configured for indicating that the data in the network response request packet is tampered with.

In an implementation, performing integrity verification on the network response request packet includes: a: Perform a digest operation on the encrypted temporary key and the ciphertext by using the second subkey in the temporary key, to obtain an operated message authentication code. b: Perform consistency comparison between the operated message authentication code and the message authentication code in the network response request packet, and determine, if consistency comparison succeeds, that integrity verification of the network response request packet succeeds, or determine, if consistency comparison fails, that integrity verification of the network response request packet fails.

3: Decryption of the ciphertext: The server 102 may decrypt the ciphertext by using the temporary key, to obtain the request data of the service request. In an implementation, the ciphertext may be decrypted by using the first subkey in the temporary key, to obtain the request data.

4: Service processing: The server 102 makes a response to the service request based on the request data. In some aspects, the server 102 may determine, based on the request data, the service processing device 103 corresponding to the service request, and forward the service request to the service processing device 103. The service processing device 103 may perform corresponding service processing in response to the service request.

From the decryption procedure, it can be learned that the message authentication code in the network response request packet is verified before the ciphertext is decrypted, so that a risk that an attacker tampers the network response request packet can be avoided. In addition, because the terminal device directly transmits the temporary key to the server, the server does not need to maintain a status of the temporary key, that is, the temporary key is not persistently stored in the server. Therefore, the key can be prevented from being leaked, improving the data security. In addition, the ciphertext is decrypted by using the first subkey, so that symmetric encryption is implemented. Therefore, a performance advantage of symmetric encryption can be fully used, and the performance is not significantly affected even though a data volume increases, effectively protecting a resource of a server from being excessively used.

The service request in this embodiment of this disclosure may include but is not limited to a login request, a service query request, a payment request, and the like. When the service request is the login request, the request data of the service request includes information about an object, account information, and the like. When the service request is the service query request, the request data of the service request may include a data identifier, data content, and the like. When the service request is the payment request, the request data of the service request may include a payment account, balance information, order information, and the like. Next, the data processing solution provided in the embodiments of this disclosure is described by using two scenarios. The first encryption algorithm includes an SM2 algorithm, the second encryption algorithm includes an SM4 algorithm, and the message digest algorithm includes the SM3 algorithm.

(1) An example in which the service request is the login request, the request data of the service request includes the information about the object, and the service processing device is a login processing device (for example, a login server) is used. In this scenario, a data processing procedure includes: 1: The object triggers a login option of the application when wanting to log in to the application. In this case, a login request initiated by the application may be detected, and a temporary key OTP1 randomly allocated to the login request is obtained. OTP1 includes a first subkey SM4 key and a second subkey SM3 key. 2: The application encrypts OTP1 by using the certificate public key based on the SM2 algorithm, to obtain an encrypted temporary key. 3: The application encrypts, by using the SM4 key based on the SM4 algorithm, the information about the object requested by the login request, to obtain a ciphertext. 4: Perform a digest operation on the ciphertext and the encrypted temporary key by using the SM3 key, to obtain a message authentication code. 5: Generate the network response request packet based on the encrypted temporary key, the ciphertext, and the message authentication code, and transmit a network response request packet to the server 102. 6: After receiving the network response request packet, the server may decrypt the encrypted temporary key by using the certificate private key, to obtain OTP1. 7: The server performs a digest operation on the encrypted temporary key and the ciphertext by using the SM3 key based on the SM3 algorithm, to obtain an operated message authentication code, and performs consistency comparison between the operated message authentication code and the message authentication code in the network response request packet. 8: When consistency comparison succeeds, the server decrypts the ciphertext by using the SM4 key based on the SM4 algorithm, to obtain the requested information about the object. 9: The server determines, based on the information about the object, that a service processing device corresponding to the login request is the login server, and then forwards the login request to the login server. 10: The login server obtains the information about the object in response to the login request, and returns the information about the object to the application, so that the application is logged in based on the information about the object.
(2) An example in which the service request is the payment request, the request data of the service request includes the order information, and the service processing device is a payment processing device is used. In this scenario, a data processing procedure includes: 1: When an object performs payment in the application, a payment request initiated by the application may be detected, and then a temporary key OPT2 randomly allocated to the payment request is obtained, where OPT2 includes a first subkey SM4 key and a second subkey SM3 key. 2: Encrypt OPT2 by using the certificate public key based on the SM2 algorithm, to obtain an encrypted temporary key. 3: Encrypt, by using the SM4 key based on the SM4 algorithm, the order information requested by the payment request, to obtain a ciphertext. 4: Perform a digest operation on the ciphertext and the encrypted temporary key by using the SM3 key based on the SM3 algorithm, to obtain a message authentication code. 5: Generate the network response request packet based on the encrypted temporary key, the ciphertext, and the message authentication code, and transmit the network response request packet to the server. 6: After receiving the network response request packet, the server may decrypt the encrypted temporary key by using the certificate private key, to obtain OPT2. 7: The server performs a digest operation on the encrypted temporary key and the ciphertext by using the SM3 key based on the SM3 algorithm, to obtain an operated message authentication code, and performs consistency comparison between the operated message authentication code and the message authentication code in the network response request packet. 8: When consistency comparison succeeds, the server decrypts the ciphertext by using the SM4 key based on the SM4 algorithm, to obtain the requested order information. 9: The server determines, based on the order information, that a service processing device corresponding to the payment request is the payment processing device, and then forwards the payment request to the payment processing device. 10: The payment processing device obtains the order information in response to the payment request, and returns the order information to the application.

The request data related to the object is involved in this embodiment of this disclosure. For example, the information about the object and the order information are involved. When the foregoing embodiment of this disclosure is applied to a product or technology, a license or consent of the object is required to be obtained, and collection, use, and processing of the related data are required to comply with related laws and regulations and standards.

In this embodiment of this disclosure, because the certificate private key is stored only in the server, the encrypted temporary key obtained through encryption with the certificate public key can only be decrypted by the server. Therefore, security of the temporary key can be well ensured. Because the temporary key is adequately secure, the ciphertext obtained through encryption with the temporary key is also adequately secure. Therefore, the data processing solution may make it difficult for an intermediate node (for example, an attacker) to crack transmitted data, ensuring security and integrity of data transmission between the application and the server. In addition, when the first encryption algorithm, the second encryption algorithm, and the message digest algorithm are all Chinese national cryptographic algorithms, data encryption may be performed completely by using the Chinese national cryptographic algorithms without using other cryptographic primitives, so that it can be ensured that the entire data processing procedure is autonomously controllable.

Next, related descriptions of a data processing method provided in the embodiments of this disclosure are provided.

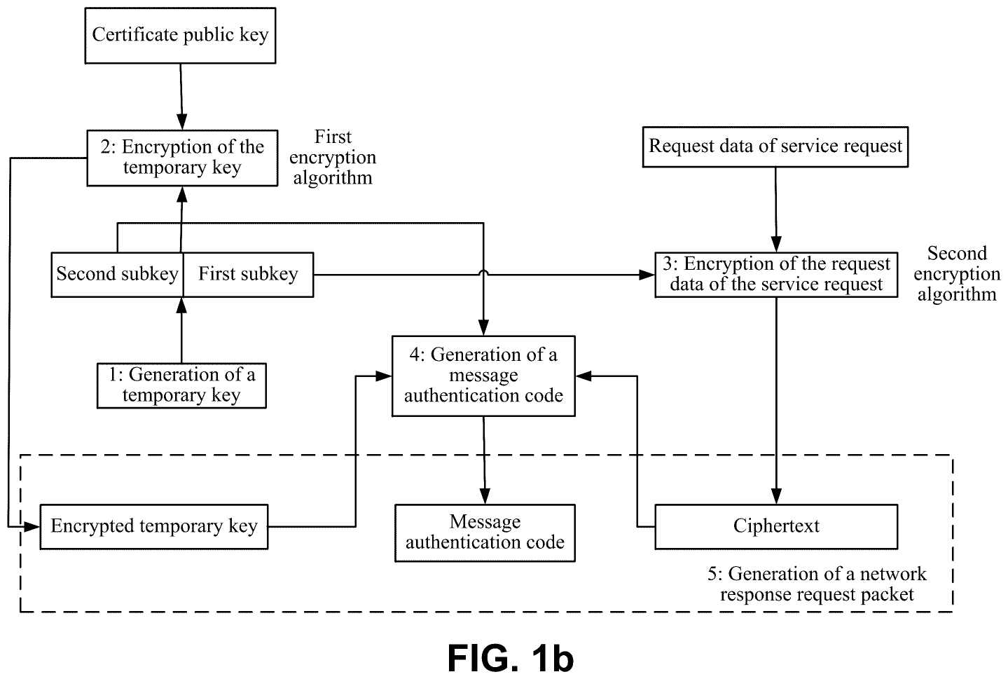

FIG. 2 is a schematic flowchart of a data processing method according to an exemplary embodiment of this disclosure. The data processing method may be performed by a terminal device, and in some aspects, may be performed by an application run on the terminal device. The data processing method may include the following operations S201 to S205.

S201: Obtain, when detecting a service request initiated by the application, a temporary key (e.g., randomly) allocated to the service request.

In an implementation, the service request may be initiated by an object by using the terminal device. For example, the object may trigger a login option when wanting to log in to the application. In this case, a login request initiated by the application may be detected. In another implementation, the service request may be initiated by the application. For example, the application is an information collection application, and the service request may include a form request for requesting form information. When the application needs to present an information collection form, the form request initiated by the application is detected.

Random allocation means allocating one temporary key to one service request, temporary keys allocated to different service requests being different. For example, the temporary key is allocated to the service request, another temporary key is allocated to a next service request, and the temporary keys allocated to the two service requests are different. In an implementation, (e.g., randomly) allocating the temporary key to the service request may include (e.g., randomly) allocating the temporary key to the service request by using a pseudo-random number generator. The pseudo-random number generator may be a cryptographically secure pseudo-random number generator (CSPRNG) or the like Use of the pseudo-random number generator can break dependence of generation of a key on a key agreement function and a key derivation function, and resolve a problem that the key agreement function and the key derivation function cannot be implemented in actual development by using an elliptic curve allowed in a Chinese national cryptographic algorithm, so that calculations and security proofs in an encryption process can be reduced.

S202: Encrypt the temporary key by using a certificate public key, to obtain an encrypted temporary key.

The application may encrypt the temporary key by using the certificate public key based on a first encryption algorithm, to obtain the encrypted temporary key. The first encryption algorithm includes an asymmetric encryption algorithm. The asymmetric encryption algorithm includes at least one of the following: an SM2 algorithm, an RSA algorithm, and a DSA. The certificate public key may be set in a source code of the application. A certificate private key corresponding to the certificate public key is stored in a server. For example, if the first encryption algorithm is the RSA algorithm, the server may first obtain a pair of public and private keys (including the certificate public key and the certificate private key) by using the RSA algorithm. The server stores the certificate private key, and broadcasts the certificate public key to the terminal device. The certificate public key includes two numbers n and e, and the certificate private key includes two numbers n and d. In an encryption process, the application raises the temporary key to the power of e, and then takes a modulus with n (that is, a process of performing encryption by using the certificate public key). In a decryption process, the server raises the encrypted temporary key to the power of d, and then takes a modulus with n (that is, a process of performing decryption by using the certificate private key). Security of the RSA algorithm lies in that when d in the certificate private key is unknown, it is very difficult to calculate d from e and n in the certificate public key. Even if the certificate public key and the encrypted temporary key are known, the original temporary key cannot be decrypted without the certificate private key.

In an implementation, the encrypting the temporary key by using the certificate public key based on a first encryption algorithm, to obtain the encrypted temporary key includes: performing asymmetric encryption processing on the temporary key by using the certificate public key based on the asymmetric encryption algorithm, to obtain the encrypted temporary key. A length of the temporary key (e.g., randomly) allocated to the service request may be a fixed length. When the key length of the temporary key is the fixed length, time consumed when the asymmetric encryption algorithm is used is controllable.

S203: Encrypt request data of the service request by using the temporary key, to obtain a ciphertext.

The application may encrypt the request data of the service request by using the temporary key based on a second encryption algorithm, to obtain the ciphertext. The second encryption algorithm may include a symmetric encryption algorithm. The symmetric encryption algorithm includes at least one of the following: a DES algorithm, a DES3 algorithm, an SM4 algorithm, and an AES algorithm. Operation S203 may include: performing symmetric encryption processing on the request data of the service request by using the temporary key based on the symmetric encryption algorithm, to obtain the ciphertext. A format of the ciphertext may be a target format. The target format is, for example, binary or quaternary.

For example, when the symmetric encryption algorithm includes the SM4 algorithm, the performing symmetric encryption processing on the request data of the service request by using the temporary key based on the symmetric encryption algorithm, to obtain the ciphertext includes the following operations. 1: Determine a data length of the request data of the service request. 2: Determine whether the data length of the request data satisfies a length condition. If the data length of the request data satisfies the length condition, operation 3 is performed; or if the data length of the request data does not satisfy the length condition, operation 6 is performed. The length condition may be set based on a requirement. For example, the length condition is set as that the data length needs to satisfy an integer multiple of a group length (for example, if the group length is 64 bits, the data length needs to satisfy an integer multiple of 64). If the data length of the request data satisfies the integer multiple of the group length, the request data does not need to be padded, and operation 3 is performed; or if the data length of the request data does not satisfy the integer multiple of the group length, the request data is padded, that is, operation 6 is performed. 3: Group the request data to obtain a plurality of groups if the data length of the request data satisfies the length condition. 4: Perform exclusive OR processing on the plurality of groups and an initialization vector through cipher block chaining (CBC) in the SM4 algorithm, to obtain a plurality of exclusive OR results. The initialization vector may be set based on a requirement. 5: Encrypt the plurality of exclusive OR results to obtain a plurality of encrypted groups, and then assemble the plurality of encrypted groups into the ciphertext. 6: Perform, if the data length of the request data does not satisfy the length condition, length padding on the request data according to a preset data padding rule, to obtain padded request data. 7: Group the padded request data to obtain a plurality of groups, and perform operations 4 and 5. The preset data padding rule may be PKCS7 (a cryptographic message syntax standard).

When the application encrypts the temporary key by using the asymmetric encryption algorithm and encrypts the request data by using the symmetric encryption algorithm (that is, the first encryption algorithm is different from the second encryption algorithm), both security of asymmetric encryption and performance of symmetric encryption can be achieved. In addition, because the first encryption algorithm is different from the second encryption algorithm, difficulty in cracking both the encrypted temporary key and the ciphertext is further increased, further ensuring data security.

S204: Generate a network response request packet based on the encrypted temporary key and the ciphertext.

During an implementation in an example, the encrypted temporary key may be determined as a packet header, the ciphertext may be determined as a packet body, and the packet header and the packet body are concatenated to form the network response request packet.

S205: Transmit the network response request packet to the server, the network response request packet being configured for requesting the server to respond to the service request.

In this embodiment of this disclosure, the temporary key (e.g., randomly) allocated to the service request is obtained when detecting the service request for the application. Then, the temporary key is encrypted by using the certificate public key based on the first encryption algorithm, to obtain the encrypted temporary key, and the request data of the service request is encrypted by using the temporary key based on the second encryption algorithm, to obtain the ciphertext. The network response request packet is generated based on the encrypted temporary key and the ciphertext, and the network response request packet is transmitted to the server, the network response request packet being configured for requesting the server to respond to the service request. According to the solution, the temporary key and the request data of the service request may be respectively encrypted by using by using different encryption algorithms, so that data security in a data transmission process can be improved. It can also be learned that the server does not need to generate the temporary key and maintain a status of the temporary key. The server only needs to passively receive the encrypted temporary key transmitted by the application, and then decrypt, by using the certificate private key in the server, the temporary key for decrypting the ciphertext. It can be learned that the server can securely obtain the temporary key only by generating the certificate public key and the corresponding certificate private key, and does not need to generate and maintain a temporary key for each service request. This can reduce data processing of the server to some extent and reduce resource overheads of the server. In addition, because the certificate private key is stored only in the server, the encrypted temporary key obtained through encryption with the certificate public key can only be decrypted by the server, which can well ensure security of the temporary key. Because the temporary key is adequately secure, the ciphertext obtained through encryption with the temporary key is also adequately secure. Therefore, the data security in the data transmission process can be well ensured by separately encrypting the temporary key and the request data of the service request.

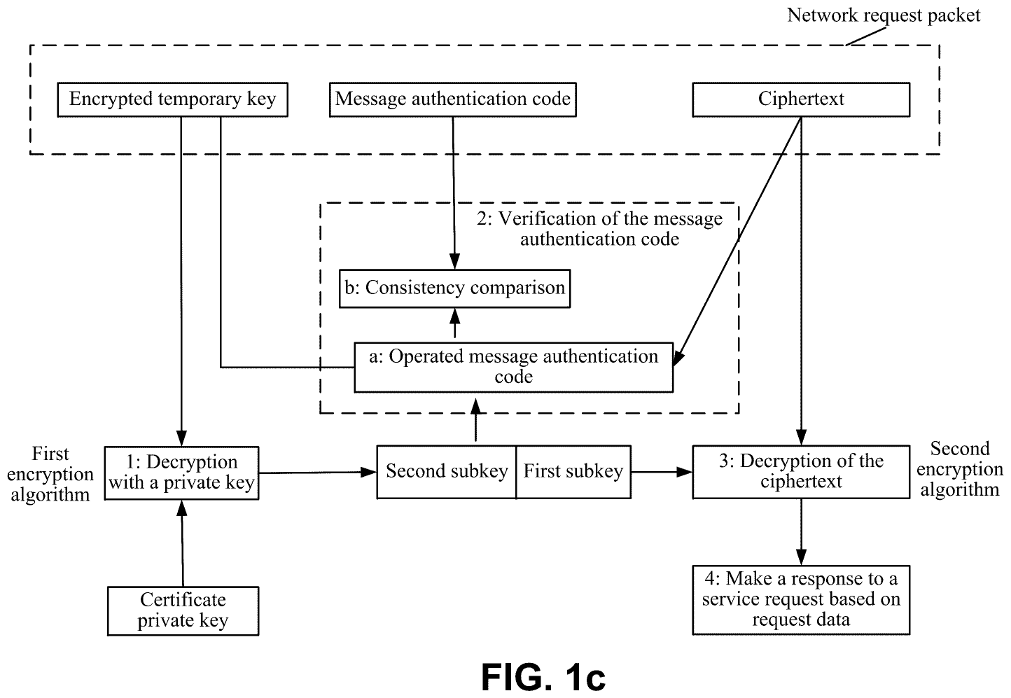

FIG. 3 is a schematic flowchart of a data processing method according to another exemplary embodiment of this disclosure. The data processing method may be performed by a terminal device, and in some examples, may be performed by an application run on the terminal device. The data processing method may include the following operations S301 to S306.

S301: Obtain, when detecting a service request initiated by the application, a temporary key (e.g., randomly) allocated to the service request.

The temporary key includes a first subkey and a second subkey. A key length of the first subkey and a key length of the second subkey may be the same or different. For example, a key length of the temporary key may be 256 bits, the first subkey may be the first 128 bits of the temporary key, and the second subkey may be the last 128 bits of the temporary key.

S302: Encrypt the temporary key by using a certificate public key based on a first encryption algorithm, to obtain an encrypted temporary key.

S303: Encrypt request data of the service request by using the temporary key based on a second encryption algorithm, to obtain a ciphertext.

In an implementation, the terminal device may obtain the first subkey from the temporary key, and then encrypt the request data of the service request by using the first subkey based on the second encryption algorithm, to obtain the ciphertext.

S304: Perform a digest operation on the encrypted temporary key and the ciphertext by using the second subkey in the temporary key, to obtain a message authentication code.

Operation S304 may include: performing the digest operation on the encrypted temporary key and the ciphertext by using the second subkey based on a message digest algorithm, to obtain the message authentication code. The message digest algorithm may include but is not limited to a digital signature algorithm. The digital signature algorithm is used as an example. The second subkey may be a key pair, that is, includes a public key and a private key. The application may first perform a hash operation on the encrypted temporary key and the ciphertext. An obtained hash value may be referred to as a digest. An algorithm for the hash operation may include SM3 (a cryptographic hash algorithm), MD5 (a message-digest algorithm), and the like. Then, the hash value is signed by using the private key in the second subkey, to obtain the message authentication code. MD5 is used as an example. An MD5 code groups input information (including the encrypted temporary key and the ciphertext) by 512 bits for processing, and each group is further divided into 16 32-bit subgroups. After a series of processing, an output of the algorithm includes four 32-bit groups, and the four 32-bit groups are cascaded to generate a 128-bit hash value (that is, the obtained hash value). Subsequently, when obtaining the second subkey, the server may decrypt the message authentication code by using the public key in the second subkey, to obtain a hash value, and then perform a hash operation on the obtained encrypted temporary key and the obtained ciphertext to obtain a to-be-verified hash value. If the hash value is the same as the to-be-verified hash value, signature verification of the message authentication code succeeds. Alternatively, the server may directly perform a hash operation on the obtained encrypted temporary key and the obtained ciphertext to obtain a to-be-verified hash value, and then sign the to-be-verified hash value by using the private key in the second subkey, to obtain an operated message authentication code. If the operated message authentication code is the same as the obtained message authentication code, the message authentication code is valid. Alternatively, the message authentication code in this disclosure may not need to be calculated by using the second subkey. For example, the application may directly perform a hash operation on the encrypted temporary key and the ciphertext, and use an operation result as the message authentication code. Subsequently, when the server obtains the message authentication code, the encrypted temporary key, and the ciphertext, the server may directly perform a hash operation on the obtained encrypted temporary key and the obtained ciphertext to obtain an operated message authentication code. If the operated message authentication code is the same as the obtained message authentication code, the message authentication code is valid.

A process of performing the digest operation on the encrypted temporary key and the ciphertext by using the second subkey, to obtain the message authentication code may further include: determining a data length of the request data, and performing the digest operation on the encrypted temporary key, the data length, an initialization vector, and the ciphertext by using the second subkey, to obtain the message authentication code. In this disclosure, the message authentication code corresponding to the encrypted temporary key and the ciphertext is calculated by using the second subkey, so that it can be ensured that the encrypted temporary key and the ciphertext obtained by the server are complete. In some examples, the server calculates, by using the second subkey, the operated message authentication code corresponding to the encrypted temporary key and the ciphertext. If the operated message authentication code is the same as the message authentication code calculated by the application, it can be authenticated that the encrypted temporary key and the ciphertext received by the server are generated by the application, that is, it is considered that the encrypted temporary key and the ciphertext transmitted to the server are untampered and complete. Therefore, it can be ensured that the temporary key and the request data of the service request that are further decrypted by the server are correct and reliable.

S305: Encapsulate the encrypted temporary key, the ciphertext, and the message authentication code to form a network response request packet.

In an implementation, operation S305 may include: determining the encrypted temporary key as the packet header, determining the ciphertext as the packet body, and determining the message authentication code as a packet trailer; and then concatenating the packet header, the packet body, and the packet trailer to form the network response request packet. Because the server first needs to decrypt the encrypted temporary key, the encrypted temporary key is placed in the packet header. In this way, the server can first obtain the encrypted temporary key in the packet header. Therefore, the server can synchronously decrypt the encrypted temporary key in the packet header in a process of receiving the packet body, and after receiving the packet body, can decrypt the ciphertext in the packet body faster based on the temporary key obtained through decryption. Similarly, because the server needs to first calculate the operated message authentication code corresponding to the encrypted temporary key and the ciphertext, the message authentication code calculated by the application is placed in the packet trailer. In this way, the server can synchronously calculate the operated message authentication code in a process of receiving the packet trailer, and after receiving the packet trailer, can perform consistency comparison between the operated message authentication code and the message authentication code in the packet trailer faster. It is noted that a data structure of the network response request packet in this disclosure enables the server to more properly perform synchronous processing in data receiving, decryption, and message authentication code verification processes, improving processing efficiency of the server.

S306: Transmit the network response request packet to the server, the network response request packet being configured for requesting the server to respond to the service request.

In this embodiment of this disclosure, the temporary key (e.g., randomly) allocated to the service request is obtained when detecting the service request for the application. Then, the temporary key is encrypted by using the certificate public key based on the first encryption algorithm, to obtain the encrypted temporary key, and the request data of the service request is encrypted by using the temporary key based on the second encryption algorithm, to obtain the ciphertext. Then, the digest operation is performed on the encrypted temporary key and the ciphertext by using the second subkey, to obtain the message authentication code, the encrypted temporary key, the ciphertext, and the message authentication code are encapsulated to form the network response request packet, and the network response request packet is transmitted to the server. According to the solution, the temporary key and the request data of the service request may be respectively encrypted by using by using different encryption algorithms, so that data security in a data transmission process can be improved. It can also be learned that the server does not need to generate the temporary key and maintain a status of the temporary key. The server only needs to passively receive the encrypted temporary key transmitted by the application, and then decrypt, by using the certificate private key in the server, the temporary key for decrypting the ciphertext. It can be learned that the server can securely obtain the temporary key only by generating the certificate public key and the corresponding certificate private key, and does not need to generate and maintain a temporary key for each service request. This can reduce data processing of the server to some extent and reduce resource overheads of the server. In addition, because the certificate private key is stored only in the server, the encrypted temporary key obtained through encryption with the certificate public key can only be decrypted by the server, which can well ensure security of the temporary key. Because the temporary key is adequately secure, the ciphertext obtained through encryption with the temporary key is also adequately secure. Therefore, the data security in the data transmission process can be well ensured by separately encrypting the temporary key and the request data of the service request. In addition, the message authentication code corresponding to the encrypted temporary key and the ciphertext is calculated by using the second subkey, so that it can be ensured that the encrypted temporary key and the ciphertext obtained by the server are complete. In some examples, the server calculates, by using the second subkey, the operated message authentication code corresponding to the encrypted temporary key and the ciphertext. If the operated message authentication code is the same as the message authentication code calculated by the application, it can be authenticated that the encrypted temporary key and the ciphertext received by the server are generated by the application, that is, it is considered that the encrypted temporary key and the ciphertext transmitted to the server are untampered and complete. Therefore, it can be ensured that the temporary key and the request data of the service request that are further decrypted by the server are correct and reliable.

The following provides supplementary descriptions of some content in the embodiments shown in FIG. 2 and FIG. 3.

In an embodiment, the key length of the temporary key (OTP) may be set based on a requirement. When the temporary key is (e.g., randomly) allocated to the service request, a temporary key of an appropriate key length may be allocated based on a priority of the request data of the service request. In an implementation, the priority of the request data is obtained, and a key length matching the priority of the request data is obtained. A higher priority of the request data indicates a higher importance level of the request data and a larger matching key length, and a larger key length indicates higher security of the request data. Then, the temporary key is (e.g., randomly) allocated to the service request based on the matching key length. It is noted that in this disclosure, a balance relationship between security and processing efficiency can be dynamically adjusted. In some examples, when the priority of the request data becomes higher, higher security is needed. In this case, the key length of the temporary key is increased, to increase cracking difficulty. When the priority of the request data becomes lower, the processing efficiency may be emphatically considered. In this case, the key length of the temporary key is reduced, to reduce calculations of the application and the server, thereby improving the processing efficiency.

In this embodiment of this disclosure, the priority of the request data and the key length of the temporary key may be further obtained, and the second encryption algorithm is selected based on one or more of the priority of the request data and the key length of the temporary key. A higher priority of the request data indicates higher complexity of the second encryption algorithm. A larger key length of the temporary key indicates higher complexity of the second encryption algorithm. Higher complexity of the second encryption algorithm indicates a lower probability that the request data is cracked after being encrypted, so that data security can be ensured better. Similarly, when the priority of the request data becomes lower or the key length of the temporary key decreases, the processing efficiency may be emphatically considered. In this case, the complexity of the second encryption algorithm is reduced, to reduce calculations of the application and the server, thereby improving the processing efficiency. It is noted that in this disclosure, the balance relationship between the security and the processing efficiency can be dynamically adjusted. For example, the priority of the request data is 3, and an importance level of the request data is high. In this case, the DES3 algorithm with high encryption complexity may be determined from the DES algorithm, the SM4 algorithm, and the DES3 algorithm as the second encryption algorithm. The encryption complexity may be determined based on factors such as a key length, a group length, and a quantity of encryption rounds in the encryption algorithm. In some examples, a larger key length, a larger group length (the group length is a length for dividing to-be-encrypted data into a plurality of blocks for processing), and a larger quantity of encryption rounds (for example, a round key is obtained by extending an initial key, and therefore, a different key is used during each round of encryption, increasing cracking difficulty) correspond to higher encryption complexity, that is, higher security of the encryption algorithm. Alternatively, a maximum quantity of original text enumeration encryption times required for cracking the ciphertext in the encryption algorithm may be used as the encryption complexity of the encryption algorithm. In some examples, a larger maximum quantity of original text enumeration encryption times indicates higher encryption complexity, that is, higher security of the encryption algorithm.

The importance level may include a privacy level. A higher privacy level indicates a higher importance level of the request data. In this case, an example of a manner of obtaining the priority of the request data includes: determining a privacy level of the request data, and determining the priority of the request data based on the privacy level of the request data. For example, a correspondence between a privacy level and a priority may be set. For example, the privacy level is 1 to 50, and the priority is 1; and the privacy level is 51 to 100, and the priority is 2. When it is determined that the privacy level of the request data is 60, it is determined that the priority of the request data is 2 based on the correspondence between a privacy level and a priority.

In an embodiment, the application may be a client installed in the terminal device, or the application may be an installation-free application. In this embodiment, the application may run in a security sandbox provided by the terminal device, and the data processing method may run in the security sandbox. In this case, the network response request packet may be verified in the security sandbox. If the network response request packet is successfully verified, the network response request packet is transmitted to the server (that is, operation S205 or operation S306 is performed); or if the network response request packet fails to be verified, verification failure prompt information is directly outputted, the verification failure prompt information being configured for indicating that the network response request packet fails to be verified. An abnormal network response request packet can be effectively isolated by the security sandbox. In some examples, when the network response request packet cannot be successfully verified in the security sandbox, the network response request packet failing to be verified (that is, an abnormal network response request packet) is isolated by the security sandbox, so that the abnormal network response request packet is not transmitted to the server. This not only protects security of the server, but also avoids unnecessary decryption and verification of the abnormal network response request by the server, and saves network traffic.

Verifying the network response request packet in the security sandbox may include any one of the following.

(1) Verify validity of the certificate public key in the security sandbox, and determine, if the validity of the certificate public key is successfully verified, that the network response request packet is successfully verified, or, determine, if the validity of the certificate public key fails to be verified, that the network response request packet fails to be verified. In some aspects, verifying the validity of the certificate public key in the security sandbox means verifying whether the certificate public key is a certificate public key that is successfully verified, and determining, if the certificate public key is the certificate public key that is successfully verified, that the validity of the certificate public key is successfully verified, or, determining, if the certificate public key is not the certificate public key that is successfully verified, that the validity of the certificate public key fails to be verified.

In an implementation, before the source code of the application is uploaded, the certificate public key is uploaded in advance. Therefore, whether the pre-uploaded certificate public key is consistent with the certificate public key in the source code of the application is verified in the security sandbox. If it is determined that the uploaded certificate public key is consistent with the certificate public key in the source code, it is determined that certificate public key is successfully verified; or if it is determined that the uploaded certificate public key is inconsistent with the certificate public key in the source code, it is determined that the certificate public key fails to be verified.

(2) Verify normativity of the network response request packet in the security sandbox, and determine, if the normativity of the network response request packet is successfully verified, that the network response request packet is successfully verified, or determine, if the normativity of the network response request packet fails to be verified, that the network response request packet fails to be verified.

The verifying normativity of the network response request packet may include at least one of the following. 1: Verify whether data in the network response request packet is encrypted, and determine, if it is determined that the data in the network response request packet is not encrypted, that the normativity of the network response request packet fails to be verified, or determine, if it is determined that the data in the network response request packet is encrypted, that the normativity of the network response request packet is successfully verified. 2: Verify whether the encrypted temporary key is obtained through encryption with a certificate public key that is successfully verified, and determine, if the encrypted temporary key is obtained through encryption with the certificate public key that is successfully verified, that the normativity of the network response request packet is successfully verified, or determine, if the encrypted temporary key is not obtained through encryption with the certificate public key that is successfully verified, that the normativity of the network response request packet fails to be verified. 3: Verify whether a format of the network response request packet is a preset format, the preset format herein being, for example, that the packet header of the network response request packet is the encrypted temporary key, the packet body is the ciphertext, and the packet trailer is the message authentication code; and determine, if the format of the network response request packet is the preset format, that the normativity of the network response request packet is successfully verified, or determine, if the format of the network response request packet is not the preset format, that the normativity of the network response request packet fails to be verified.

(3) Verify validity of the certificate public key and normativity of the network response request packet in the security sandbox, and determine, if the validity of the certificate public key is successfully verified and the normativity of the network response request packet is successfully verified, that the network response request packet is successfully verified, or determine, if the validity of the certificate public key fails to be verified, the normativity of the network response request packet fails to be verified, or the validity of the certificate public key fails to be verified and the normativity of the network response request packet fails to be verified, that the network response request packet fails to be verified.

In conclusion, data encryption is performed in the security sandbox, so that security of data encryption can be ensured to some extent. In addition, the network response request packet is verified in the security sandbox before the network response request packet is transmitted, so that it can be ensured that the data in the network response request packet is encrypted and the network response request packet is normative, further ensuring data security.

Next, related descriptions of a decryption procedure on a server side are provided below.

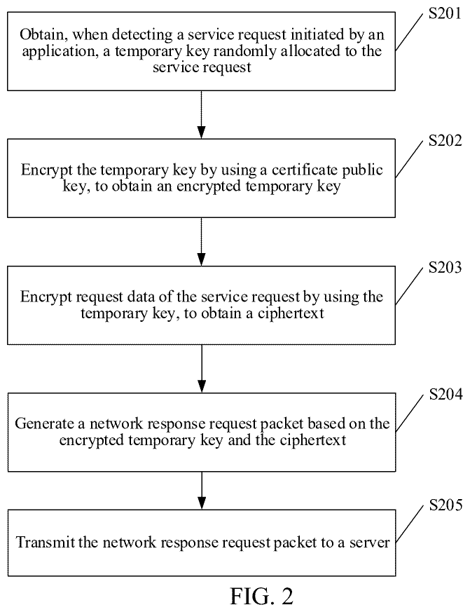

FIG. 4 is a schematic flowchart of a data processing method according to still another embodiment of this disclosure. The data processing method may be performed by a server. The server may be the server in the foregoing data processing system. The data processing method may include the following operations S401 to S404.

S401: Receive a network response request packet transmitted by an application. The network response request packet includes an encrypted temporary key and a ciphertext. The encrypted temporary key is obtained by a terminal device by encrypting a temporary key by using a certificate public key. The ciphertext is obtained by the terminal device by encrypting request data of a service request by using the temporary key.

S402: Decrypt the encrypted temporary key by using a certificate private key, the temporary key (e.g., randomly) allocated to the service request of the application being obtained through decryption if the encrypted temporary key is obtained through encryption with the certificate public key that is preset in a source code of the application.

In some aspects, the certificate private key is obtained, and the encrypted temporary key is decrypted by using the certificate private key based on a first encryption algorithm. If decryption succeeds, the encrypted temporary key is obtained through encryption with the certificate public key (the certificate public key is generated based on the certificate private key) preset in the source code of the application, that is, the temporary key may be obtained through decryption.

S403: Decrypt the ciphertext by using the temporary key, to obtain the request data of the service request.

The server may decrypt the ciphertext by using the temporary key based on a second encryption algorithm, to obtain the request data of the service request. The temporary key includes a first subkey. In an implementation, the server reads a packet body from the network response request packet, to obtain the ciphertext, then obtains the first subkey from the temporary key, and decrypts the ciphertext by using the first subkey based on the second encryption algorithm, to obtain the request data of the service request.

In an implementation, the second encryption algorithm includes an SM4 algorithm, and the ciphertext includes a plurality of encrypted groups. Decrypting the ciphertext by using the first subkey based on the second encryption algorithm, to obtain the request data of the service request includes: decrypting the plurality of encrypted groups to obtain a plurality of decrypted groups, obtaining an initialization vector, and performing exclusive OR processing on the plurality of decrypted groups based on the initialization vector, to obtain the request data of the service request.

S404: Make a response to the service request based on the request data.

In an implementation, the making a response to the service request based on the request data may include: determining, based on the request data, a service processing device corresponding to the service request, and forwarding the service request to the service processing device. For example, the service request is a login request, the request data is information about an object, the server may determine, based on the request data, that the service processing device corresponding to the service request is a login processing device, and the server may forward the service request to the login processing device to perform login processing.

After the service processing device performs service processing in response to the service request, in an implementation, the service processing device may directly return a service processing result to the application. In another implementation, the service processing device may return a service processing result to the server, and the server returns the service processing result to the application, so that the application makes a response based on the service processing result. For example, the login processing device may obtain the information about the object based on the login request, and directly return the information about the object to the application. The application displays a functional interface of the application based on the information about the object, to complete login to the application.

In this embodiment of this disclosure, the network response request packet transmitted by the application is received. The network response request packet includes the encrypted temporary key and the ciphertext. The encrypted temporary key is decrypted by using the certificate private key based on the first encryption algorithm, to obtain the temporary key (e.g., randomly) allocated to the service request of the application. The ciphertext is decrypted by using the temporary key based on the second encryption algorithm, to obtain the request data of the service request. The response is made to the service request based on the request data. It can be learned that in a data transmission process, the temporary key and the request data of the service request may be respectively encrypted by using by using different encryption algorithms, so that data security in the data transmission process can be improved. In addition, the server does not need to generate the temporary key and maintain a status of the temporary key. The server only needs to passively receive the encrypted temporary key transmitted by the application, and then decrypt, by using the certificate private key in the server, the temporary key for decrypting the ciphertext. It can be learned that the server can securely obtain the temporary key only by generating the certificate public key and the corresponding certificate private key, and does not need to generate and maintain a temporary key for each service request. This can reduce data processing of the server to some extent and reduce resource overheads of the server. In addition, because the certificate private key is stored only in the server, the encrypted temporary key obtained through encryption with the certificate public key can only be decrypted by the server, which can well ensure security of the temporary key. Because the temporary key is adequately secure, the ciphertext obtained through encryption with the temporary key is also adequately secure. Therefore, the data security in the data transmission process can be well ensured by separately encrypting the temporary key and the request data of the service request.

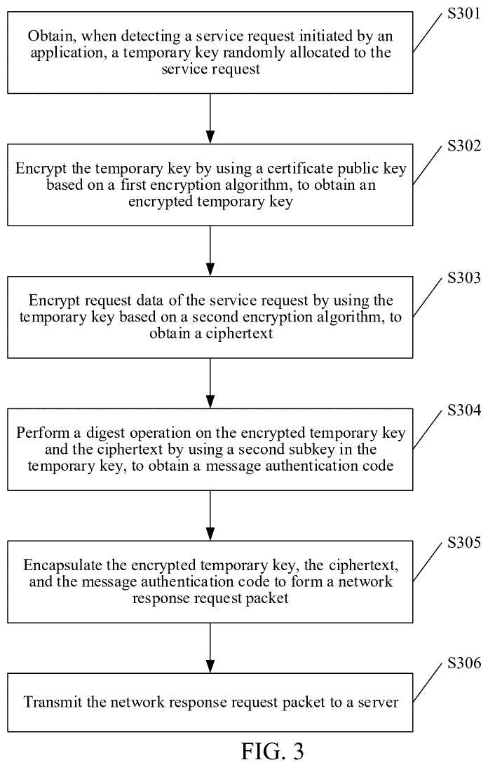

FIG. 5 is a schematic flowchart of a data processing method according to yet another embodiment of this disclosure. The data processing method may be performed by a server. The server may be the server in the foregoing data processing system. The data processing method may include the following operations S501 to S506.

S501: Receive a network response request packet transmitted by an application. The network response request packet includes an encrypted temporary key, a ciphertext, and a message authentication code. The encrypted temporary key is obtained by a terminal device by encrypting a temporary key by using a certificate public key. The ciphertext is obtained by the terminal device by encrypting request data of a service request by using the temporary key.

S502: Decrypt the encrypted temporary key by using a certificate private key based on a first encryption algorithm, to obtain the temporary key (e.g., randomly) allocated to the service request of the application, the temporary key including a first subkey and a second subkey.

The network response request packet may include a packet header, a packet body, and a packet trailer. The server may read the packet header from the network response request packet to obtain the encrypted temporary key, and decrypt the encrypted temporary key by using the certificate private key based on the first encryption algorithm, to obtain the temporary key.

S503: Perform a digest operation on the encrypted temporary key and the ciphertext by using the second subkey, to obtain an operated message authentication code.

In an implementation, the digest operation may be performed on the encrypted temporary key and the ciphertext by using the second subkey based on a message digest algorithm, to obtain the operated message authentication code. In another implementation, the network response request packet further includes a data length and an initialization vector, and the digest operation may be performed on the encrypted temporary key, the data length, the initialization vector, and the ciphertext by using the second subkey based on a message digest algorithm, to obtain the operated message authentication code.

S504: Perform consistency comparison between the operated message authentication code and the message authentication code in the network response request packet.

The packet trailer of the network response request packet includes the message authentication code. If consistency comparison between the operated message authentication code obtained through the operation and the message authentication code in the packet trailer succeeds, data in the network response request packet is complete and untampered, and operation S505 is performed; or if consistency comparison between the operated message authentication code obtained through the operation and the message authentication code in the packet trailer fails, data in the network response request packet is tampered with, and prompt information is returned to the terminal device, the prompt information being configured for prompting that the data in the network response request packet has a risk of being tampered with. In this disclosure, the message authentication code corresponding to the encrypted temporary key and the ciphertext is calculated by using the second subkey, so that it can be ensured that the encrypted temporary key and the ciphertext obtained by the server are complete. In some examples, the server calculates, by using the second subkey, the operated message authentication code corresponding to the encrypted temporary key and the ciphertext. If the operated message authentication code is the same as the message authentication code calculated by the application, it can be authenticated that the encrypted temporary key and the ciphertext received by the server are generated by the application, that is, it is considered that the encrypted temporary key and the ciphertext transmitted to the server are untampered and complete. Therefore, it can be ensured that the temporary key and the request data of the service request that are further decrypted by the server are correct and reliable.

S505: Decrypt, if consistency comparison succeeds, the ciphertext by using the temporary key based on a second encryption algorithm, to obtain the request data of the service request.

In an implementation, the server may obtain the first subkey from the temporary key, and decrypt the ciphertext by using the first subkey based on the second encryption algorithm, to obtain the request data of the service request.

S506: Make a response to the service request based on the request data.

In this embodiment of this disclosure, the network response request packet transmitted by the application is received. The network response request packet includes the encrypted temporary key and the ciphertext. Then, the encrypted temporary key is decrypted by using the certificate private key based on the first encryption algorithm, to obtain the temporary key (e.g., randomly) allocated to the service request of the application, the temporary key including the first subkey and the second subkey. Next, the digest operation is performed on the encrypted temporary key and the ciphertext by using the second subkey, to obtain the operated message authentication code, and consistency comparison is performed between the operated message authentication code obtained through the operation and the message authentication code in the network response request packet. If consistency comparison succeeds, the ciphertext is decrypted by using the temporary key based on the second encryption algorithm, to obtain the request data of the service request, and then the response is made to the service request based on the request data. The message authentication code in the network response request packet is verified before the ciphertext is decrypted, so that a risk that an attacker tampers the network response request packet can be avoided. In addition, because the terminal device directly transmits the temporary key to the server, the server does not need to maintain a status of the temporary key, that is, the temporary key is not stored in the server. Therefore, the key can be prevented from being leaked, improving the data security. In addition, the ciphertext is decrypted by using the same first subkey, so that symmetric encryption is implemented. Therefore, a performance advantage of symmetric encryption can be fully used, and the performance is not significantly affected even though a data volume increases, effectively protecting a resource of a server from being excessively used.

Next, related descriptions of a data processing apparatus provided in the embodiments of this disclosure are provided.

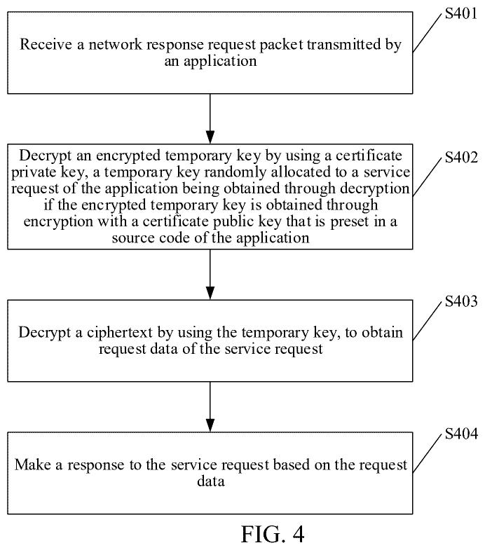

FIG. 6 is a schematic diagram of a structure of a data processing apparatus according to an embodiment of this disclosure. The data processing apparatus may be a computer program (including program code) in a computer device. For example, the data processing apparatus may be application software in the computer device. The data processing apparatus may be configured to perform some or all of the operations in the method embodiments shown in FIG. 2 and FIG. 3. Refer to FIG. 6. The data processing apparatus includes the following units: a processing unit 601, configured to obtain, when detecting a service request initiated by an application, a temporary key (e.g., randomly) allocated to the service request; the processing unit 601 being further configured to encrypt the temporary key by using a certificate public key, to obtain an encrypted temporary key, the certificate public key being preset in a source code of the application, and a certificate private key corresponding to the certificate public key being stored in a server; the processing unit 601 being further configured to encrypt request data of the service request by using the temporary key, to obtain a ciphertext; the processing unit 601 being further configured to generate a network response request packet based on the encrypted temporary key and the ciphertext; and a transmission unit 602, configured to transmit the network response request packet to the server, the network response request packet being configured for requesting the server to respond to the service request.

The processing unit 601 is configured to encrypt the temporary key by using the certificate public key based on a first encryption algorithm, to obtain the encrypted temporary key.

The processing unit 601 is configured to encrypt the request data of the service request by using the temporary key based on a second encryption algorithm, to obtain the ciphertext, the first encryption algorithm being different from the second encryption algorithm.

Random allocation means allocating one temporary key to one service request, temporary keys allocated to different service requests being different.

The certificate public key is set in the source code of the application. The certificate private key corresponding to the certificate public key is stored in the server.

The first encryption algorithm includes an asymmetric encryption algorithm. The asymmetric encryption algorithm includes at least one of the following: an elliptic curve public key cryptography algorithm, an asymmetric encryption algorithm based on a large integer factorization problem, and a digital signature algorithm.

The second encryption algorithm includes a symmetric encryption algorithm. The symmetric encryption algorithm includes at least one of the following: a key-based block cipher algorithm, a block cipher algorithm, a triple data encryption algorithm, and an advanced encryption standard algorithm.

The temporary key includes a first subkey. The processing unit 601 is configured to: obtain the first subkey from the temporary key; and encrypt the request data of the service request by using the first subkey based on the second encryption algorithm, to obtain the ciphertext.

The temporary key further includes a second subkey. The processing unit 601 is configured to: perform a digest operation on the encrypted temporary key and the ciphertext by using the second subkey, to obtain a message authentication code; and encapsulate the encrypted temporary key, the ciphertext, and the message authentication code to form the network response request packet.

The processing unit 601 is configured to: determine the encrypted temporary key as a packet header, determine the ciphertext as a packet body, and determine the message authentication code as a packet trailer; and concatenate the packet header, the packet body, and the packet trailer to form the network response request packet.

The processing unit 601 is further configured to: obtain a priority of the request data; obtain a key length matching the priority of the request data; and allocate the temporary key (e.g., randomly) to the service request based on the matching key length.

A higher priority of the request data indicates a higher importance level of the request data and a larger matching key length.

The processing unit 601 is further configured to: obtain the priority of the request data and a key length of the temporary key; and determine the second encryption algorithm based on one or two of the priority of the request data or the key length of the temporary key.

A higher priority of the request data indicates higher complexity of the second encryption algorithm. A larger key length of the temporary key indicates higher complexity of the second encryption algorithm.

The application is an installation-free application. The application is run in a security sandbox. The method is run in the security sandbox. The processing unit 601 is further configured to: verify the network response request packet in the security sandbox; and perform, if the network response request packet is successfully verified, the operation of transmitting the network response request packet to the server.

The verification includes any one of the following: verifying validity of the certificate public key; and verifying normativity of the network response request packet.

The verifying normativity of the network response request packet includes at least one of the following: verifying whether data in the network response request packet is encrypted, and determining, if it is determined that the data in the network response request packet is not encrypted, that the normativity of the network response request packet fails to be verified, or determining, if it is determined that the data in the network response request packet is encrypted, that the normativity of the network response request packet is successfully verified; verifying whether the encrypted temporary key is obtained through encryption with a certificate public key that is successfully verified, and determining, if the encrypted temporary key is obtained through encryption with the certificate public key that is successfully verified, that the normativity of the network response request packet is successfully verified, or determining, if the encrypted temporary key is not obtained through encryption with the certificate public key that is successfully verified, that the normativity of the network response request packet fails to be verified; and verifying whether a format of the network response request packet is a preset format, and determining, if the format of the network response request packet is the preset format, that the normativity of the network response request packet is successfully verified, or determining, if the format of the network response request packet is not the preset format, that the normativity of the network response request packet fails to be verified, the preset format being that the packet header of the network response request packet is the encrypted temporary key, the packet body is the ciphertext, and the packet trailer is the message authentication code.

In this embodiment of this disclosure, the temporary key (e.g., randomly) allocated to the service request is obtained when detecting the service request for the application. Then, the temporary key is encrypted by using the certificate public key based on the first encryption algorithm, to obtain the encrypted temporary key, and the request data of the service request is encrypted by using the temporary key based on the second encryption algorithm, to obtain the ciphertext. The network response request packet is generated based on the encrypted temporary key and the ciphertext, and the network response request packet is transmitted to the server, the network response request packet being configured for requesting the server to respond to the service request. According to the solution, before data transmission, the temporary key and the request data of the service request may be respectively encrypted by using by using different encryption algorithms, so that data security in a data transmission process can be improved. In addition, it can be learned that the server does not need to generate the temporary key and maintain a status of the temporary key. The server only needs to passively receive the encrypted temporary key transmitted by the application, and then decrypt, by using the certificate private key in the server, the temporary key for decrypting the ciphertext. It can be learned that the server can securely obtain the temporary key only by generating the certificate public key and the corresponding certificate private key, and does not need to generate and maintain a temporary key for each service request. This can reduce data processing of the server to some extent and reduce resource overheads of the server. In addition, because the certificate private key is stored only in the server, the encrypted temporary key obtained through encryption with the certificate public key can only be decrypted by the server, which can well ensure security of the temporary key. Because the temporary key is adequately secure, the ciphertext obtained through encryption with the temporary key is also adequately secure. Therefore, the data security in the data transmission process can be well ensured by separately encrypting the temporary key and the request data of the service request.

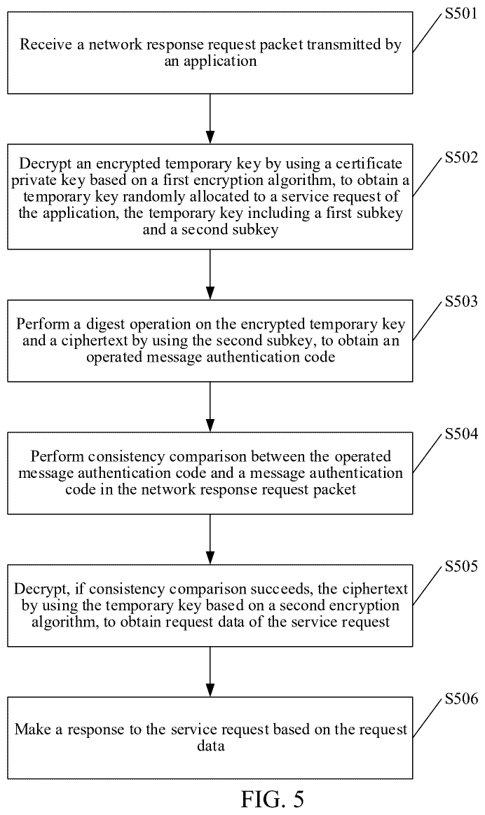

FIG. 7 is a schematic diagram of a structure of a data processing apparatus according to an embodiment of this disclosure. The data processing apparatus may be a computer program (including program code) in a computer device. For example, the data processing apparatus may be application software in the computer device. The data processing apparatus may be configured to perform some or all of the operations in the method embodiments shown in FIG. 4 and FIG. 5. Refer to FIG. 7. The data processing apparatus includes the following units: a receiving unit 701, configured to receive a network response request packet transmitted by an application, the network response request packet including an encrypted temporary key and a ciphertext; and a processing unit 702, configured to decrypt the encrypted temporary key by using a certificate private key, a temporary key (e.g., randomly) allocated to a service request of the application being obtained through decryption if the encrypted temporary key is obtained through encryption with a certificate public key that is preset in a source code of the application.

The processing unit 702 is further configured to decrypt the ciphertext by using the temporary key, to obtain request data of the service request.

The processing unit 702 is further configured to make a response to the service request based on the request data.

The temporary key includes a first subkey and a second subkey, the first subkey being configured for decrypting the ciphertext. The network response request packet further includes a message authentication code. The processing unit 702 is further configured to: perform a digest operation on the encrypted temporary key and the ciphertext by using the second subkey, to obtain an operated message authentication code; perform consistency comparison between the operated message authentication code and the message authentication code in the network response request packet; and perform, if consistency comparison succeeds, an operation of decrypting the ciphertext by using the temporary key based on a second encryption algorithm, to obtain the request data of the service request.

The processing unit 702 is configured to: determine, based on the request data, a service processing device corresponding to the service request; and forward the service request to the service processing device for service processing.

In this embodiment of this disclosure, the network response request packet transmitted by the application is received. The network response request packet includes the encrypted temporary key and the ciphertext. The encrypted temporary key is decrypted by using the certificate private key based on the first encryption algorithm, to obtain the temporary key (e.g., randomly) allocated to the service request of the application. The ciphertext is decrypted by using the temporary key based on the second encryption algorithm, to obtain the request data of the service request. The response is made to the service request based on the request data. It can be learned that in a data transmission process, the temporary key and the request data of the service request may be respectively encrypted by using by using different encryption algorithms, so that data security in the data transmission process can be improved. In addition, it can be learned that the server does not need to generate the temporary key and maintain a status of the temporary key. The server only needs to passively receive the encrypted temporary key transmitted by the application, and then decrypt, by using the certificate private key in the server, the temporary key for decrypting the ciphertext. It can be learned that the server can securely obtain the temporary key only by generating the certificate public key and the corresponding certificate private key, and does not need to generate and maintain a temporary key for each service request. This can reduce data processing of the server to some extent and reduce resource overheads of the server. In addition, because the certificate private key is stored only in the server, the encrypted temporary key obtained through encryption with the certificate public key can only be decrypted by the server, which can well ensure security of the temporary key. Because the temporary key is adequately secure, the ciphertext obtained through encryption with the temporary key is also adequately secure. Therefore, the data security in the data transmission process can be well ensured by separately encrypting the temporary key and the request data of the service request.

Next, related descriptions of a computer device provided in the embodiments of this application are provided.

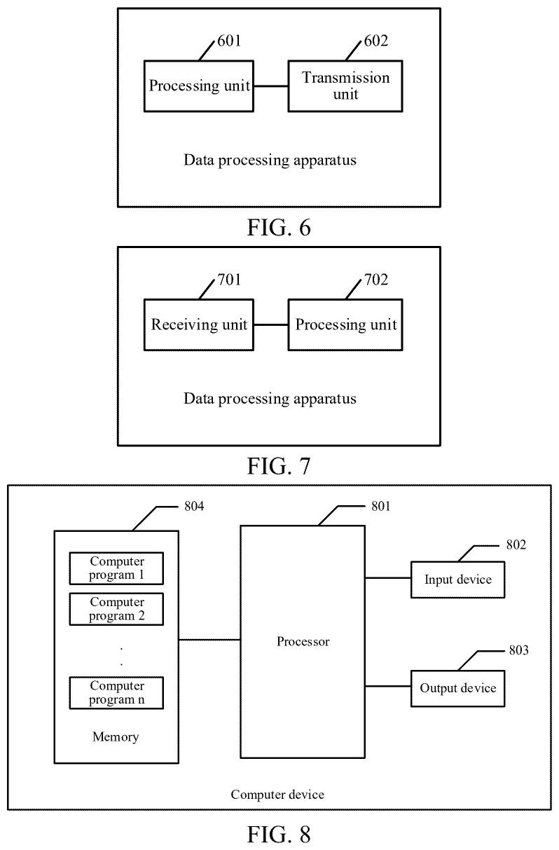

Further, an embodiment of this application further provides a schematic diagram of a structure of a computer device. For schematic diagram of the structure of the computer device, refer to FIG. 8. The computer device may include a processor 801, an input device 802, an output device 803, and a memory 804. The processor 801, the input device 802, the output device 803, and the memory 804 are connected through a bus. The memory 804 is configured to store a computer program. The computer program includes program instructions. The processor 801 is configured to execute the program instructions stored in the memory 804.

In an embodiment, the computer device may be the foregoing terminal device. In this embodiment, by running the program instructions in the memory 804, the processor 801 performs the following operations: obtaining, when detecting a service request initiated by an application, a temporary key (e.g., randomly) allocated to the service request; encrypting the temporary key by using a certificate public key, to obtain an encrypted temporary key, the certificate public key being preset in a source code of the application, and the certificate private key corresponding to the certificate public key being stored in a server; encrypting request data of the service request by using the temporary key, to obtain a ciphertext; and generating a network response request packet based on the encrypted temporary key and the ciphertext, and transmitting the network response request packet to the server, the network response request packet being configured for requesting the server to respond to the service request.

When encrypting the temporary key by using the certificate public key, to obtain the encrypted temporary key, the processor 801 may perform the following operation: encrypting the temporary key by using the certificate public key based on a first encryption algorithm, to obtain the encrypted temporary key.

When encrypting the request data of the service request by using the temporary key, to obtain the ciphertext, the processor 801 may perform the following operation: encrypting the request data of the service request by using the temporary key based on a second encryption algorithm, to obtain the ciphertext, the first encryption algorithm being different from the second encryption algorithm.

Random allocation means allocating one temporary key to one service request, temporary keys allocated to different service requests being different.

The certificate public key is set in the source code of the application. The certificate private key corresponding to the certificate public key is stored in the server.

The first encryption algorithm includes an asymmetric encryption algorithm. The asymmetric encryption algorithm includes at least one of the following: an elliptic curve public key cryptography algorithm, an asymmetric encryption algorithm based on a large integer factorization problem, and a digital signature algorithm.

The second encryption algorithm includes a symmetric encryption algorithm. The symmetric encryption algorithm includes at least one of the following: a key-based block cipher algorithm, a block cipher algorithm, a triple data encryption algorithm, and an advanced encryption standard algorithm.

The temporary key includes a first subkey. When encrypting the request data of the service request by using the temporary key based on the second encryption algorithm, to obtain the ciphertext, the processor 801 may perform the following operations: obtaining the first subkey from the temporary key; and encrypting the request data of the service request by using the first subkey based on the second encryption algorithm, to obtain the ciphertext.

The temporary key further includes a second subkey. When generating the network response request packet based on the encrypted temporary key and the ciphertext, the processor 801 may perform the following operations: performing a digest operation on the encrypted temporary key and the ciphertext by using the second subkey, to obtain a message authentication code; and encapsulating the encrypted temporary key, the ciphertext, and the message authentication code to form the network response request packet.

When encapsulating the encrypted temporary key, the ciphertext, and the message authentication code to form the network response request packet, the processor 801 may perform the following operations: determining the encrypted temporary key as a packet header, determining the ciphertext as a packet body, and determining the message authentication code as a packet trailer; and concatenating the packet header, the packet body, and the packet trailer to form the network response request packet.

The processor 801 may further perform the following operations: obtaining a priority of the request data; obtaining a key length matching the priority of the request data; and allocating the temporary key (e.g., randomly) to the service request based on the matching key length.

A higher priority of the request data indicates a higher importance level of the request data and a larger matching key length.

The processor 801 may further perform the following operations: obtaining the priority of the request data and a key length of the temporary key; and determining the second encryption algorithm based on one or two of the priority of the request data or the key length of the temporary key.

A higher priority of the request data indicates higher complexity of the second encryption algorithm. A larger key length of the temporary key indicates higher complexity of the second encryption algorithm.

The application is an installation-free application. The application is run in a security sandbox. The method is run in the security sandbox. The processor 801 may further perform the following operations: verifying the network response request packet in the security sandbox; and performing, if the network response request packet is successfully verified, the operation of transmitting the network response request packet to the server.

The verification includes any one of the following: verifying validity of the certificate public key; and verifying normativity of the network response request packet.

The verifying normativity of the network response request packet includes at least one of the following: verifying whether data in the network response request packet is encrypted, and determining, if it is determined that the data in the network response request packet is not encrypted, that the normativity of the network response request packet fails to be verified, or determining, if it is determined that the data in the network response request packet is encrypted, that the normativity of the network response request packet is successfully verified; verifying whether the encrypted temporary key is obtained through encryption with a certificate public key that is successfully verified, and determining, if the encrypted temporary key is obtained through encryption with the certificate public key that is successfully verified, that the normativity of the network response request packet is successfully verified, or determining, if the encrypted temporary key is not obtained through encryption with the certificate public key that is successfully verified, that the normativity of the network response request packet fails to be verified; and verifying whether a format of the network response request packet is a preset format, and determining, if the format of the network response request packet is the preset format, that the normativity of the network response request packet is successfully verified, or determining, if the format of the network response request packet is not the preset format, that the normativity of the network response request packet fails to be verified, the preset format being that the packet header of the network response request packet is the encrypted temporary key, the packet body is the ciphertext, and the packet trailer is the message authentication code.

In this embodiment of this disclosure, the temporary key (e.g., randomly) allocated to the service request is obtained when detecting the service request for the application. Then, the temporary key is encrypted by using the certificate public key based on the first encryption algorithm, to obtain the encrypted temporary key, and the request data of the service request is encrypted by using the temporary key based on the second encryption algorithm, to obtain the ciphertext. The network response request packet is generated based on the encrypted temporary key and the ciphertext, and the network response request packet is transmitted to the server, the network response request packet being configured for requesting the server to respond to the service request. According to the solution, before data transmission, the temporary key and the request data of the service request may be respectively encrypted by using by using different encryption algorithms, so that data security in a data transmission process can be improved. In addition, it can be learned that the server does not need to generate the temporary key and maintain a status of the temporary key. The server only needs to passively receive the encrypted temporary key transmitted by the application, and then decrypt, by using the certificate private key in the server, the temporary key for decrypting the ciphertext. It can be learned that the server can securely obtain the temporary key only by generating the certificate public key and the corresponding certificate private key, and does not need to generate and maintain a temporary key for each service request. This can reduce data processing of the server to some extent and reduce resource overheads of the server. In addition, because the certificate private key is stored only in the server, the encrypted temporary key obtained through encryption with the certificate public key can only be decrypted by the server, which can well ensure security of the temporary key. Because the temporary key is adequately secure, the ciphertext obtained through encryption with the temporary key is also adequately secure. Therefore, the data security in the data transmission process can be well ensured by separately encrypting the temporary key and the request data of the service request.

In another embodiment, the computer device may be the foregoing server. In this embodiment, by running the program instructions in the memory 804, the processor 801 performs the following operations: receiving a network response request packet transmitted by an application, the network response request packet including an encrypted temporary key and a ciphertext; decrypting the encrypted temporary key by using a certificate private key, a temporary key (e.g., randomly) allocated to a service request of the application being obtained through decryption if the encrypted temporary key is obtained through encryption with a certificate public key that is preset in a source code of the application; decrypting the ciphertext by using the temporary key, to obtain request data of the service request; and making a response to the service request based on the request data.

The temporary key includes a first subkey and a second subkey, the first subkey being configured for decrypting the ciphertext. The network response request packet further includes a message authentication code. The processor 801 may further perform the following operations: performing a digest operation on the encrypted temporary key and the ciphertext by using the second subkey, to obtain an operated message authentication code; performing consistency comparison between the operated message authentication code and the message authentication code in the network response request packet; and performing, if consistency comparison succeeds, an operation of decrypting the ciphertext by using the temporary key based on a second encryption algorithm, to obtain the request data of the service request.

When making the response to the service request based on the request data, the processor 801 may further perform the following operations: determining, based on the request data, a service processing device corresponding to the service request; and forwarding the service request to the service processing device for service processing.

In this embodiment of this disclosure, the network response request packet transmitted by the application is received. The network response request packet includes the encrypted temporary key and the ciphertext. The encrypted temporary key is decrypted by using the certificate private key based on the first encryption algorithm, to obtain the temporary key (e.g., randomly) allocated to the service request of the application. The ciphertext is decrypted by using the temporary key based on the second encryption algorithm, to obtain the request data of the service request. The response is made to the service request based on the request data. It can be learned that in a data transmission process, the temporary key and the request data of the service request may be respectively encrypted by using by using different encryption algorithms, so that data security in the data transmission process can be improved. In addition, it can be learned that the server does not need to generate the temporary key and maintain a status of the temporary key. The server only needs to passively receive the encrypted temporary key transmitted by the application, and then decrypt, by using the certificate private key in the server, the temporary key for decrypting the ciphertext. It can be learned that the server can securely obtain the temporary key only by generating the certificate public key and the corresponding certificate private key, and does not need to generate and maintain a temporary key for each service request. This can reduce data processing of the server to some extent and reduce resource overheads of the server. In addition, because the certificate private key is stored only in the server, the encrypted temporary key obtained through encryption with the certificate public key can only be decrypted by the server, which can well ensure security of the temporary key. Because the temporary key is adequately secure, the ciphertext obtained through encryption with the temporary key is also adequately secure. Therefore, the data security in the data transmission process can be well ensured by separately encrypting the temporary key and the request data of the service request.

In addition, an embodiment of this disclosure further provides a computer-readable storage medium. The computer-readable storage medium has a computer program stored therein. The computer program includes program instructions. When executing the program instructions, a processor can perform the methods in the embodiments corresponding to FIG. 2 to FIG. 5. Therefore, details are not described herein again. For technical details that are not disclosed in the embodiment of the computer-readable storage medium in this disclosure, refer to the descriptions of the method embodiments of this disclosure. In an example, the program instructions may be deployed to be executed on one computer device, on a plurality of computer devices at the same location, or on a plurality of computer devices that are distributed at a plurality of locations and interconnected by using a communication network.

According to an aspect of this disclosure, a computer program product is provided. The computer program product includes a computer program. The computer program is stored in a computer-readable storage medium. A processor of a computer device reads the computer program from the computer-readable storage medium. The processor runs the computer program, so that the computer device may perform the methods in the embodiments corresponding to FIG. 2 to FIG. 5. Therefore, details are not described herein again.

It is noted that all or some of the procedures of the methods in the foregoing embodiments may be implemented by a computer program instructing relevant hardware. The program may be stored in a computer-readable storage medium. When the program is executed, the procedures of the foregoing method embodiments may be implemented. The foregoing storage medium may include a magnetic disc, an optical disc, a read-only memory (ROM), a random access memory (RAM), or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of data processing, comprising:
allocating, when a service request is initiated by an application running on a terminal device, a temporary key to the service request;
encrypting the temporary key by using a certificate public key, to obtain an encrypted temporary key, the certificate public key being preset in a source code of the application, and a certificate private key associated with the certificate public key being stored in a server for the application;
encrypting request data of the service request by using the temporary key, to obtain at least a ciphertext;
generating a network response request packet based on the encrypted temporary key and the ciphertext; and
transmitting the network response request packet to the server, the network response request packet requesting the server to respond to the service request.

2. The method according to claim 1, wherein:
the encrypting the temporary key comprises:
encrypting the temporary key by using the certificate public key based on a first encryption algorithm, to obtain the encrypted temporary key; and
the encrypting the request data comprises:
encrypting the request data of the service request by using the temporary key based on a second encryption algorithm, to obtain the ciphertext, the first encryption algorithm being different from the second encryption algorithm.

3. The method according to claim 2, wherein the temporary key comprises a first subkey; and the encrypting the request data comprises:
obtaining the first subkey from the temporary key; and
encrypting the request data of the service request by using the first subkey based on the second encryption algorithm, to obtain the ciphertext.

4. The method according to claim 3, wherein the temporary key further comprises a second subkey; and the generating the network response request packet comprises:
performing a digest operation on the encrypted temporary key and the ciphertext by using the second subkey, to obtain a message authentication code; and
encapsulating the encrypted temporary key, the ciphertext, and the message authentication code to form the network response request packet.

5. The method according to claim 4, wherein the encapsulating comprises:
setting the encrypted temporary key as a packet header, the ciphertext as a packet body, and the message authentication code as a packet trailer; and
concatenating the packet header, the packet body, and the packet trailer to form the network response request packet.

6. The method according to claim 1, wherein:
the method further comprises:
obtaining a priority of the request data;
obtaining a matching key length to the priority of the request data; and
allocating the temporary key to the service request based on the matching key length, and
a higher priority of the request data indicates a higher importance level of the request data and a longer matching key length.

7. The method according to claim 2, wherein:
the method further comprises:
obtaining a priority of the request data and a key length of the temporary key; and
determining the second encryption algorithm based on one or both of the priority of the request data and the key length of the temporary key,
a higher priority of the request data indicates a higher complexity of the second encryption algorithm, and
a longer key length of the temporary key indicates a higher complexity of the second encryption algorithm.

8. The method according to claim 1, wherein the application is an installation-free application; the application is running in a security sandbox; and the method further comprises:
verifying the network response request packet in the security sandbox; and
performing, when the network response request packet is successfully verified, the transmitting the network response request packet to the server.

9. The method according to claim 8, wherein the verifying comprises at least one of:
verifying a validity of the certificate public key; and
verifying a normativity of the network response request packet.

10. The method according to claim 9, wherein:
the verifying the normativity of the network response request packet comprises:
verifying whether data in the network response request packet is encrypted;
determining, when the data in the network response request packet is not encrypted, that the normativity of the network response request packet fails to be verified; and
determining, when the data in the network response request packet is encrypted, that the normativity of the network response request packet is successfully verified.

11. The method according to claim 9, wherein:
the verifying the normativity of the network response request packet comprises:
verifying whether the encrypted temporary key is obtained through an encryption with a certificate public key has been successfully verified;
determining, when the encrypted temporary key is obtained through the encryption with the certificate public key that has been successfully verified, that the normativity of the network response request packet is successfully verified; and
determining, when the encrypted temporary key is not obtained through the encryption with the certificate public key that has been successfully verified, that the normativity of the network response request packet fails to be verified.

12. The method according to claim 9, wherein:
the verifying the normativity of the network response request packet comprises:
verifying whether a format of the network response request packet is a preset format;
determining, when the format of the network response request packet is the preset format, that the normativity of the network response request packet is successfully verified; and
determining, when the format of the network response request packet is not the preset format, that the normativity of the network response request packet fails to be verified, and
the preset format includes:
a packet header of the network response request packet that includes the encrypted temporary key,
a packet body that includes the ciphertext, and
a packet trailer that includes a message authentication code.

13. The method according to claim 2, wherein:
different temporary keys allocated to different service requests being different;
the first encryption algorithm comprises an asymmetric encryption algorithm, and the asymmetric encryption algorithm comprises at least one of: an elliptic curve public key cryptography algorithm, an asymmetric encryption algorithm based on a large integer factorization problem, or a digital signature algorithm; and
the second encryption algorithm comprises a symmetric encryption algorithm, and the symmetric encryption algorithm comprises at least one of: a key-based block cipher algorithm, a block cipher algorithm, a triple data encryption algorithm, or an advanced encryption standard algorithm.

14. A method of data processing, comprising:
receiving, by a server for an application, a network response request packet that is transmitted based on the application running on a terminal device, the network response request packet comprising an encrypted temporary key and a ciphertext of a service request from the terminal device;
decrypting the encrypted temporary key by using a certificate private key to recover a temporary key, the temporary key being allocated to the service request and being encrypted into the encrypted temporary key based on a certificate public key, the certificate public key being associated with the certificate private key and being preset in a source code of the application;
decrypting the ciphertext by using the temporary key, to obtain request data of the service request; and
generating a response to the service request based on the request data.

15. The method according to claim 14, wherein the temporary key comprises a first subkey and a second subkey, the first subkey is used in the decrypting the ciphertext; the network response request packet comprises a message authentication code; and the method further comprises:
performing a digest operation on the encrypted temporary key and the ciphertext by using the second subkey, to obtain an operated message authentication code;
performing a consistency comparison between the operated message authentication code and the message authentication code in the network response request packet; and
performing, when the consistency comparison succeeds, the decrypting the ciphertext.

16. The method according to claim 14, wherein the generating the response comprises:
determining, based on the request data, a service processing device for the service request; and
forwarding the service request to the service processing device for a service processing.

17. An apparatus of data processing, comprising processing circuitry configured to:
obtain, when a service request initiated by an application of the apparatus, a temporary key that is allocated to the service request;
encrypt the temporary key by using a certificate public key, to obtain an encrypted temporary key, the certificate public key being preset in a source code of the application, and a certificate private key associated with the certificate public key being stored in a server for the application;
encrypt request data of the service request by using the temporary key, to obtain at least a ciphertext;
generate a network response request packet based on the encrypted temporary key and the ciphertext; and
transmit the network response request packet to the server, the network response request packet requesting the server to respond to the service request.

18. The apparatus according to claim 17, wherein the processing circuitry is configured to:
encrypt the temporary key by using the certificate public key based on a first encryption algorithm, to obtain the encrypted temporary key; and
encrypt the request data of the service request by using the temporary key based on a second encryption algorithm, to obtain the ciphertext, the first encryption algorithm being different from the second encryption algorithm.

19. The apparatus according to claim 18, wherein the temporary key comprises a first subkey; and the processing circuitry is configured to:
obtain the first subkey from the temporary key; and
encrypt the request data of the service request by using the first subkey based on the second encryption algorithm, to obtain the ciphertext.

20. The apparatus according to claim 19, wherein the temporary key further comprises a second subkey; and the processing circuitry is configured to:
perform a digest operation on the encrypted temporary key and the ciphertext by using the second subkey, to obtain a message authentication code; and
encapsulate the encrypted temporary key, the ciphertext, and the message authentication code to form the network response request packet.
